(19) United States
(12) Patent Application Publication
(10) Pub. No.: US 2026/0370380 A1
(43) Pub. Date: Nov. 19, 2026

(54) RESOURCE MAPPING FOR PROBABILISTIC AMPLITUDE SHAPING

(71) Applicant: QUALCOMM Incorporated, San Diego, CA (US)

(72) Inventors: Liangming WU, Beijing (CN); Jing JIANG, San Diego, CA (US); Wei YANG, San Diego, CA (US); Wei LIU, Beijing (CN); Kexin XIAO, Shanghai (CN); Changlong XU, Beijing (CN); Thomas Joseph RICHARDSON, South Orange, NJ (US)

(21) Appl. No.: 19/126,173

(22) PCT Filed: Jan. 5, 2023
(86) PCT No.: PCT/CN2023/070652

§ 371 Date: Apr. 30, 2025

(51) Int. Cl. H04L 1/00; H04W 72/0446; H04W 72/0453

(52) U.S. Cl. CPC H04L 1/0042; H04L 1/0064; H04L 1/0071; H04W 72/0446; H04W 72/0453

(57) ABSTRACT

Methods, systems, and devices for wireless communications are described. A wireless device may generate a first set of shaped symbols using a first distribution matcher corresponding to a first frequency subband, and a second set of shaped symbols using a second distribution matcher corresponding to a second frequency subband. The wireless device may segment the first set of shaped symbols into a first set of subblocks and may segment the second set of shaped symbols into a second set of subblocks. The wireless device may concatenate one or more subblocks from the first set of subblocks with one or more subblocks from the second set of subblocks. The wireless device may map the set of concatenated shaped symbols to a set of resources according to a frequency-first, time-second ordering. The wireless device may transmit the set of concatenated shaped symbols via the set of resources based on the mapping.

### CROSS REFERENCE

The present Application for Patent is a 371 national phase filing of International Patent Application No. PCT/CN2023/070652 by WU et al., entitled “RESOURCE MAPPING FOR PROBABILISTIC AMPLITUDE SHAPING,” filed Jan. 5, 2023, assigned to the assignee hereof, and expressly incorporated by reference herein.

### FIELD OF TECHNOLOGY

The following relates to wireless communications, including resource mapping for probabilistic amplitude shaping (PAS).

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The described techniques relate to improved methods, systems, devices, and apparatuses that support resource mapping for probabilistic amplitude shaping (PAS). For example, the described techniques provide for a wireless device to utilize, as part of a probabilistic shaping procedure, one or more distribution matchers that each correspond to a respective frequency subband, and to concatenate outputs of the distribution matchers for resource mapping across the frequency subbands. The wireless device may input a first subset of a set of information bits into a first distribution matcher to generate a first set of shaped symbols and may additionally input a second subset of the set of information bits into a second distribution matcher to generate a second set of shaped symbols. The first distribution matcher may correspond to a first frequency subband and the second distribution matcher may correspond to a second frequency subband. In some examples, a block size of the first distribution matcher may be based on a size of the first frequency subband and a block size of the second distribution matcher may be based on a size of the second frequency subband.

The wireless device may segment the first set of shaped symbols into a first set of subblocks and may segment the second set of shaped symbols into a second set of subblocks. To obtain a set of concatenated shaped symbols, the wireless device may concatenate one or more subblocks from the first set of subblocks with one or more subblocks from the second set of subblocks. The wireless device may encode the set of concatenated shaped symbols, for example, using forward error correction (FEC). After encoding, the wireless device may map the set of concatenated shaped symbols to a set of resources according to a frequency-first, time-second ordering. The wireless device may transmit a message including the set of concatenated shaped symbols via the set of resources based on the mapping.

A method for wireless communications at a wireless device is described. The method may include generating, using a first distribution matcher of the wireless device, a first set of shaped symbols corresponding to a first subset of a set of information bits, the first distribution matcher associated with a first frequency subband, generating, using a second distribution matcher of the wireless device, a second set of shaped symbols corresponding to a second subset of the set of information bits, the second distribution matcher associated with a second frequency subband, segmenting the first set of shaped symbols into a first set of subblocks, where each subblock of the first set of subblocks includes a respective subset of the first set of shaped symbols, segmenting the second set of shaped symbols into a second set of subblocks, where each subblock of the second set of subblocks includes a respective subset of the second set of shaped symbols, concatenating a first subblock of the first set of subblocks with a second subblock of the second set of subblocks to obtain a first set of concatenated shaped symbols, where the first set of concatenated shaped symbols is associated with the first frequency subband and the second frequency subband, and transmitting a message including at least the first set of concatenated shaped symbols.

An apparatus for wireless communications at a wireless device is described. The apparatus may include a processor, memory coupled with the processor, and instructions stored in the memory. The instructions may be executable by the processor to cause the apparatus to generate, using a first distribution matcher of the wireless device, a first set of shaped symbols corresponding to a first subset of a set of information bits, the first distribution matcher associated with a first frequency subband, generate, using a second distribution matcher of the wireless device, a second set of shaped symbols corresponding to a second subset of the set of information bits, the second distribution matcher associated with a second frequency subband, segment the first set of shaped symbols into a first set of subblocks, where each subblock of the first set of subblocks includes a respective subset of the first set of shaped symbols, segment the second set of shaped symbols into a second set of subblocks, where each subblock of the second set of subblocks includes a respective subset of the second set of shaped symbols, concatenate a first subblock of the first set of subblocks with a second subblock of the second set of subblocks to obtain a first set of concatenated shaped symbols, where the first set of concatenated shaped symbols is associated with the first frequency subband and the second frequency subband, and transmit a message including at least the first set of concatenated shaped symbols.

Another apparatus for wireless communications at a wireless device is described. The apparatus may include means for generating, using a first distribution matcher of the wireless device, a first set of shaped symbols corresponding to a first subset of a set of information bits, the first distribution matcher associated with a first frequency subband, means for generating, using a second distribution matcher of the wireless device, a second set of shaped symbols corresponding to a second subset of the set of information bits, the second distribution matcher associated with a second frequency subband, means for segmenting the first set of shaped symbols into a first set of subblocks, where each subblock of the first set of subblocks includes a respective subset of the first set of shaped symbols, means for segmenting the second set of shaped symbols into a second set of subblocks, where each subblock of the second set of subblocks includes a respective subset of the second set of shaped symbols, means for concatenating a first subblock of the first set of subblocks with a second subblock of the second set of subblocks to obtain a first set of concatenated shaped symbols, where the first set of concatenated shaped symbols is associated with the first frequency subband and the second frequency subband, and means for transmitting a message including at least the first set of concatenated shaped symbols.

A non-transitory computer-readable medium storing code for wireless communications at a wireless device is described. The code may include instructions executable by a processor to generate, using a first distribution matcher of the wireless device, a first set of shaped symbols corresponding to a first subset of a set of information bits, the first distribution matcher associated with a first frequency subband, generate, using a second distribution matcher of the wireless device, a second set of shaped symbols corresponding to a second subset of the set of information bits, the second distribution matcher associated with a second frequency subband, segment the first set of shaped symbols into a first set of subblocks, where each subblock of the first set of subblocks includes a respective subset of the first set of shaped symbols, segment the second set of shaped symbols into a second set of subblocks, where each subblock of the second set of subblocks includes a respective subset of the second set of shaped symbols, concatenate a first subblock of the first set of subblocks with a second subblock of the second set of subblocks to obtain a first set of concatenated shaped symbols, where the first set of concatenated shaped symbols is associated with the first frequency subband and the second frequency subband, and transmit a message including at least the first set of concatenated shaped symbols.

Some examples of the method, apparatuses, and non-transitory computer-readable medium described herein may further include operations, features, means, or instructions for mapping the first set of shaped symbols to a first time-frequency matrix representation of a resource grid, where segmenting the first set of shaped symbols may be based on the first time-frequency matrix representation and mapping the second set of shaped symbols to a second time-frequency matrix representation of the resource grid, where segmenting the second set of shaped symbols may be based on the second time-frequency matrix representation.

In some examples of the method, apparatuses, and non-transitory computer-readable medium described herein, the first time-frequency matrix representation corresponds to a first quantity of frequency domain resources and a first quantity of time domain resources and the second time-frequency matrix representation corresponds to a second quantity of frequency domain resources and a second quantity of time domain resources.

In some examples of the method, apparatuses, and non-transitory computer-readable medium described herein, a quantity of subblocks of the first set of subblocks may be associated with the first quantity of time domain resources and a quantity of subblocks of the second set of subblocks may be associated with the second quantity of time domain resources.

In some examples of the method, apparatuses, and non-transitory computer-readable medium described herein, a quantity of symbols of the first set of concatenated shaped symbols may be equal to a sum of the first quantity of frequency domain resources and the second quantity of frequency domain resources.

Some examples of the method, apparatuses, and non-transitory computer-readable medium described herein may further include operations, features, means, or instructions for concatenating a third subblock of the first set of subblocks with a fourth subblock of the second set of subblocks to obtain a second set of concatenated shaped symbols, where the message further includes the second set of concatenated shaped symbols.

Some examples of the method, apparatuses, and non-transitory computer-readable medium described herein may further include operations, features, means, or instructions for performing a first symbol-to-bit conversion operation on the first set of concatenated shaped symbols to obtain a first bit stream and performing a second symbol-to-bit conversion operation on the second set of concatenated shaped symbols to obtain a second bit stream.

Some examples of the method, apparatuses, and non-transitory computer-readable medium described herein may further include operations, features, means, or instructions for interleaving the first bit stream and the second bit stream based on the first frequency subband and the second frequency subband to obtain an interleaved bit stream and encoding the interleaved bit stream using an encoder of the wireless device, where transmitting the message may be based on the encoding.

In some examples, the method, apparatuses, and non-transitory computer-readable medium may include further operations, features, means, or instructions for multiplexing the set of parity bits with one or more unshaped information bits of the set of information bits, where transmitting the message may be based on the multiplexing.

Some examples of the method, apparatuses, and non-transitory computer-readable medium described herein may further include operations, features, means, or instructions for performing a symbol-to-bit conversion operation on the first set of concatenated shaped symbols to obtain a first bit stream and encoding the first bit stream using an encoder of the wireless device, where transmitting the message may be based on the encoding.

In some examples of the method, apparatuses, and non-transitory computer-readable medium described herein, encoding the first bit stream may include operations, features, means, or instructions for generating, using the encoder of the wireless device, a set of parity bits based on the first set of concatenated shaped symbols.

Some examples of the method, apparatuses, and non-transitory computer-readable medium described herein may further include operations, features, means, or instructions for multiplexing the set of parity bits with one or more unshaped information bits of the set of information bits to obtain a set of multiplexed bits and interleaving multiplexed bits of the set of multiplexed bits based on the first frequency subband and the second frequency subband, where transmitting the message may be based on the interleaving.

In some examples of the method, apparatuses, and non-transitory computer-readable medium described herein, transmitting the message may include operations, features, means, or instructions for mapping the first set of concatenated shaped symbols to a set of resources based on a frequency-first, time-second ordering, where the message may be transmitted via the set of resources.

In some examples of the method, apparatuses, and non-transitory computer-readable medium described herein, a block size of the first distribution matcher may be based on a size of the first frequency subband and a block size of the second distribution matcher may be based on a size of the second frequency subband.

Some examples of the method, apparatuses, and non-transitory computer-readable medium described herein may further include operations, features, means, or instructions for receiving control signaling indicating the size of the first frequency subband and the size of the second frequency subband.

In some examples of the method, apparatuses, and non-transitory computer-readable medium described herein, the size of the first frequency subband and the size of the second frequency subband may be based on a bandwidth.

Some examples of the method, apparatuses, and non-transitory computer-readable medium described herein may further include operations, features, means, or instructions for receiving a signal indicating one or more parameters for the first distribution matcher, one or more parameters for the second distribution matcher, or a combination thereof.

### BRIEF DESCRIPTION OF THE DRAWINGS

FIG. 1 illustrates an example of a wireless communications system that supports resource mapping for probabilistic amplitude shaping (PAS) in accordance with one or more aspects of the present disclosure.

FIG. 2 illustrates an example of a wireless communications system that supports resource mapping for PAS in accordance with one or more aspects of the present disclosure.

FIG. 3 illustrates an example of an encoding process that supports resource mapping for PAS in accordance with one or more aspects of the present disclosure.

FIG. 4 illustrates an example of an encoding process that supports resource mapping for PAS in accordance with one or more aspects of the present disclosure.

FIG. 5 illustrates an example of a process flow that supports resource mapping for PAS in accordance with one or more aspects of the present disclosure.

FIGS. 6 and 7 illustrate block diagrams of devices that support resource mapping for PAS in accordance with one or more aspects of the present disclosure.

FIG. 8 illustrates a block diagram of a communications manager that supports resource mapping for PAS in accordance with one or more aspects of the present disclosure.

FIG. 9 illustrates a diagram of a system including a network entity that supports resource mapping for PAS in accordance with one or more aspects of the present disclosure.

FIG. 10 illustrates a diagram of a system including a UE that supports resource mapping for PAS in accordance with one or more aspects of the present disclosure.

FIGS. 11 through 13 illustrate flowcharts showing methods that support resource mapping for PAS in accordance with one or more aspects of the present disclosure.

### DETAILED DESCRIPTION

In some wireless systems, data may be modulated by a transmitting device for transmission to a receiving device by shaping the data into a constellation of modulated symbols. Each point in the constellation may represent one or more bits. In some cases, some wireless communications systems may utilize higher order modulation to increase spectral efficiency for wireless transmissions. In some cases, a distribution of modulated symbols may be shaped such that different symbols of a symbol constellation may have different probabilities of usage (e.g., some symbols may be more likely to be mapped to, and thus transmitted over the air, than other symbols). Such a distribution may be referred to as a non-uniform distribution of symbols. For example, modulation symbols associated with lower amplitudes may be selected with greater likelihood (and thus more often over time or in connection with a given set of bits) than modulation symbols associated with higher amplitudes, which may provide power savings, improved spectral efficiency, or other benefits.

The distribution of symbols may be shaped using one or more probabilistic shaping techniques. Probabilistic shaping may be a technique used to increase spectral efficiency of the coded modulation, and may generate non-uniformly distributed coded modulation symbols, or non-uniformly distributed constellations. In some examples, non-uniformly distributed symbols may have a higher capacity and may result in higher transmission capacities, higher spectral efficiencies, or generally higher communication quality than uniform symbol distributions. An example of a probabilistic shaping framework may be probabilistic amplitude shaping (PAS) (e.g., distribution matching), which may combine constellation shaping with channel coding techniques. PAS may shape an amplitude of a constellation of modulated symbols (e.g., the amplitude may be non-uniform).

For example, to support PAS, a transmitting device may utilize a distribution matcher to perform distribution matching on a set of information bits for which constellation mapping (e.g., the selection of corresponding modulation symbols from a symbol constellation) is to be performed. It may be assumed that, prior to distribution matching, the set of information bits are uniformly (e.g., randomly) distributed, such that each individual bit may have an equal likelihood of being a 0 or a 1. Distribution matching may include converting the set of information bits (e.g., k input bits) into a corresponding sequence of symbols (e.g., n symbols), where different symbols within a pool of possible symbols have different likelihoods of being included in the corresponding sequence of symbols—that is, the different possible symbols may have different associated probabilities of selection in accordance with a non-uniform probability distribution (e.g., associated with the distribution matcher). For example, where different symbols correspond to different amplitudes (e.g., where the symbols are amplitude-shift keying (ASK) symbols), some amplitudes may be more likely to be included in the sequence than others based on the non-uniform probability distribution.

PAS operations, however, may be restricted to layers or bandwidths that have similar spatial or frequency selectivity. More precisely, to perform PAS for transmission(s) via multiple layers or bandwidths, the multiple layers or bandwidths must share similar signal-to-noise ratios (SNRs). Thus, in some scenarios, the transmitting device may utilize different distribution matchers for different frequency bands, layers, etc. Moreover, some parameters of a PAS procedure, such as a block length (also referred to as a block size), may rely on resources allocated for the transmission(s). For limited-resource transmissions, the block length may be relatively short, which may introduce significant rate loss.

The present disclosure provides techniques for a probabilistic shaping framework in which outputs of distribution matchers may be concatenated across respective frequency bands or frequency subbands. For example, a transmitting device may utilize, as part of a PAS procedure for a set of information bits, a first distribution matcher associated with a first frequency subband and a second distribution matcher associated with a second frequency subband. The transmitting device may segment shaped symbols output from the first distribution matcher and shaped symbols output from the second distribution matcher into a first set of subblocks and a second set of subblocks, respectively. For example, the transmitting device may segment the shaped symbols based on a size of the first frequency subband and a size of the second frequency subband. The transmitting device may concatenate each subblock of the first set of subblocks with a respective subblock of the second set of subblocks to obtain a set of concatenated subblocks. The concatenated subblocks may thus be associated with both the first frequency subband and the second frequency subband, which may increase a block length for the PAS procedure and reduce the likelihood of rate loss.

The transmitting device may perform symbol-to-bit conversion to convert the concatenated subblocks into a set of shaped bits for encoding. In some examples, the transmitting device may interleave the set of shaped bits prior to encoding. Additionally, or alternatively, the transmitting device may multiplex and interleave parity bits generated via the encoding with unshaped information bits. After encoding, the transmitting device may map the encoded shaped bits (e.g., and any multiplexed unshaped bits) to a set of resources for transmission according to a frequency-first, time-second ordering. For example, the transmitting device may map the encoded shaped bits to frequency-domain resources of the set of resources before mapping the encoded shaped bits to time-domain resources of the set of resources, and may transmit the encoded shaped bits via the set of resources.

Aspects of the disclosure are initially described in the context of wireless communications systems. Aspects of the disclosure are then discussed with reference to encoding processes and a process flow. Aspects of the disclosure are further illustrated by and described with reference to apparatus diagrams, system diagrams, and flowcharts that relate to resource mapping for PAS.

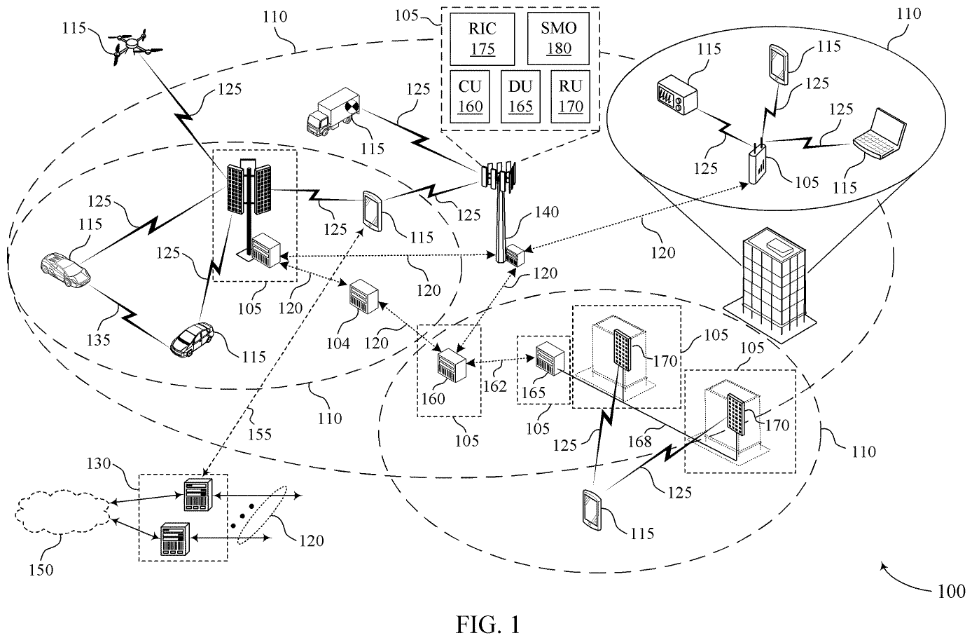

FIG. 1 illustrates an example of a wireless communications system 100 that supports resource mapping for PAS in accordance with one or more aspects of the present disclosure. The wireless communications system 100 may include one or more network entities 105, one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via one or more communication links 125 (e.g., a radio frequency (RF) access link). For example, a network entity 105 may support a coverage area 110 (e.g., a geographic coverage area) over which the UEs 115 and the network entity 105 may establish one or more communication links 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices, such as other UEs 115 or network entities 105, as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some examples, network entities 105 may communicate with one another via a backhaul communication link 120 (e.g., in accordance with an X2, Xn, or other interface protocol) either directly (e.g., directly between network entities 105) or indirectly (e.g., via a core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 via a communication link 155.

One or more of the network entities 105 described herein may include or may be referred to as a base station 140 (e.g., a base transceiver station, a radio base station, an NR base station, an access point, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) 160, a distributed unit (DU) 165, a radio unit (RU) 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, and any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaption protocol (SDAP), Packet Data Convergence Protocol (PDCP)). The CU 160 may be connected to one or more DUs 165 or RUs 170, and the one or more DUs 165 or RUS 170 may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1, F1-c, F1-u), and a DU 165 may be connected to one or more RUs 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities 105 that are in communication via such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (vIAB-MT)). In some examples, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

For instance, an access network (AN) or RAN may include communications between access nodes (e.g., an IAB donor), IAB nodes 104, and one or more UEs 115. The IAB donor may facilitate connection between the core network 130 and the AN (e.g., via a wired or wireless connection to the core network 130). That is, an IAB donor may refer to a RAN node with a wired or wireless connection to core network 130. The IAB donor may include a CU 160 and at least one DU 165 (e.g., and RU 170), in which case the CU 160 may communicate with the core network 130 via an interface (e.g., a backhaul link). IAB donor and IAB nodes 104 may communicate via an F1 interface according to a protocol that defines signaling messages (e.g., an F1 AP protocol). Additionally, or alternatively, the CU 160 may communicate with the core network via an interface, which may be an example of a portion of backhaul link, and may communicate with other CUs 160 (e.g., a CU 160 associated with an alternative IAB donor) via an Xn-C interface, which may be an example of a portion of a backhaul link.

An IAB node 104 may refer to a RAN node that provides IAB functionality (e.g., access for UEs 115, wireless self-backhauling capabilities). A DU 165 may act as a distributed scheduling node towards child nodes associated with the IAB node 104, and the IAB-MT may act as a scheduled node towards parent nodes associated with the IAB node 104. That is, an IAB donor may be referred to as a parent node in communication with one or more child nodes (e.g., an IAB donor may relay transmissions for UEs through one or more other IAB nodes 104). Additionally, or alternatively, an IAB node 104 may also be referred to as a parent node or a child node to other IAB nodes 104, depending on the relay chain or configuration of the AN. Therefore, the IAB-MT entity of IAB nodes 104 may provide a Uu interface for a child IAB node 104 to receive signaling from a parent IAB node 104, and the DU interface (e.g., DUs 165) may provide a Uu interface for a parent IAB node 104 to signal to a child IAB node 104 or UE 115.

For example, IAB node 104 may be referred to as a parent node that supports communications for a child IAB node, or referred to as a child IAB node associated with an IAB donor, or both. The IAB donor may include a CU 160 with a wired or wireless connection (e.g., a backhaul communication link 120) to the core network 130 and may act as parent node to IAB nodes 104. For example, the DU 165 of IAB donor may relay transmissions to UEs 115 through IAB nodes 104, or may directly signal transmissions to a UE 115, or both. The CU 160 of IAB donor may signal communication link establishment via an F1 interface to IAB nodes 104, and the IAB nodes 104 may schedule transmissions (e.g., transmissions to the UEs 115 relayed from the IAB donor) through the DUs 165. That is, data may be relayed to and from IAB nodes 104 via signaling via an NR Uu interface to MT of the IAB node 104. Communications with IAB node 104 may be scheduled by a DU 165 of IAB donor and communications with IAB node 104 may be scheduled by DU 165 of IAB node 104.

In the case of the techniques described herein applied in the context of a disaggregated RAN architecture, one or more components of the disaggregated RAN architecture may be configured to support resource mapping for PAS as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) using resources associated with one or more carriers. The term “carrier” may refer to a set of RF spectrum resources having a defined physical layer structure for supporting the communication links 125. For example, a carrier used for a communication link 125 may include a portion of a RF spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

In some examples, such as in a carrier aggregation configuration, a carrier may also have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be identified according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different radio access technology).

The communication links 125 shown in the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular radio access technology (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications using a particular carrier bandwidth or may be configurable to support communications using one of a set of carrier bandwidths. In some examples, the wireless communications system 100 may include network entities 105 or UEs 115 that support concurrent communications using carriers associated with multiple carrier bandwidths. In some examples, each served UE 115 may be configured for operating using portions (e.g., a sub-band, a BWP) or all of a carrier bandwidth.

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

One or more numerologies for a carrier may be supported, and a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

A network entity 105 may provide communication coverage via one or more cells, for example a macro cell, a small cell, a hot spot, or other types of cells, or any combination thereof. The term “cell” may refer to a logical communication entity used for communication with a network entity 105 (e.g., using a carrier) and may be associated with an identifier for distinguishing neighboring cells (e.g., a physical cell identifier (PCID), a virtual cell identifier (VCID), or others). In some examples, a cell also may refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a lower-powered network entity 105 (e.g., a lower-powered base station 140), as compared with a macro cell, and a small cell may operate using the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A network entity 105 may support one or multiple cells and may also support communications via the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a network entity 105 (e.g., a base station 140, an RU 170) may be movable and therefore provide communication coverage for a moving coverage area 110. In some examples, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

Some UEs 115, such as MTC or IoT devices, may be low cost or low complexity devices and may provide for automated communication between machines (e.g., via Machine-to-Machine (M2M) communication). M2M communication or MTC may refer to data communication technologies that allow devices to communicate with one another or a network entity 105 (e.g., a base station 140) without human intervention. In some examples, M2M communication or MTC may include communications from devices that integrate sensors or meters to measure or capture information and relay such information to a central server or application program that uses the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs 115 via a device-to-device (D2D) communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to each of the other UEs 115 in the group. In some examples, a network entity 105 may facilitate the scheduling of resources for D2D communications. In some other examples, D2D communications may be carried out between the UEs 115 without an involvement of a network entity 105.

In some systems, a D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (e.g., network entities 105, base stations 140, RUs 170) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than 100 kilometers) compared to communications using the smaller frequencies and longer waves of the high frequency (HF) or very high frequency (VHF) portion of the spectrum below 300 MHz.

The wireless communications system 100 may also operate using a super high frequency (SHF) region, which may be in the range of 3 GHz to 30 GHz, also known as the centimeter band, or using an extremely high frequency (EHF) region of the spectrum (e.g., from 30 GHz to 300 GHz), also known as the millimeter band. In some examples, the wireless communications system 100 may support millimeter wave (mmW) communications between the UEs 115 and the network entities 105 (e.g., base stations 140, RUs 170), and EHF antennas of the respective devices may be smaller and more closely spaced than UHF antennas. In some examples, such techniques may facilitate using antenna arrays within a device. The propagation of EHF transmissions, however, may be subject to even greater attenuation and shorter range than SHF or UHF transmissions. The techniques disclosed herein may be employed across transmissions that use one or more different frequency regions, and designated use of bands across these frequency regions may differ by country or regulating body.

The wireless communications system 100 may utilize both licensed and unlicensed RF spectrum bands. For example, the wireless communications system 100 may employ License Assisted Access (LAA), LTE-Unlicensed (LTE-U) radio access technology, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

The network entities 105 or the UEs 115 may use MIMO communications to exploit multipath signal propagation and increase spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry information associated with the same data stream (e.g., the same codeword) or different data streams (e.g., different codewords). Different spatial layers may be associated with different antenna ports used for channel measurement and reporting. MIMO techniques include single-user MIMO (SU-MIMO), for which multiple spatial layers are transmitted to the same receiving device, and multiple-user MIMO (MU-MIMO), for which multiple spatial layers are transmitted to multiple devices.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A network entity 105 or a UE 115 may use beam sweeping techniques as part of beamforming operations. For example, a network entity 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (e.g., by a transmitting device, such as a network entity 105, or by a receiving device, such as a UE 115) a beam direction for later transmission or reception by the network entity 105.

Some signals, such as data signals associated with a particular receiving device, may be transmitted by transmitting device (e.g., a transmitting network entity 105, a transmitting UE 115) along a single beam direction (e.g., a direction associated with the receiving device, such as a receiving network entity 105 or a receiving UE 115). In some examples, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some examples, transmissions by a device (e.g., by a network entity 105 or a UE 115) may be performed using multiple beam directions, and the device may use a combination of digital precoding or beamforming to generate a combined beam for transmission (e.g., from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted along one or more directions by a network entity 105 (e.g., a base station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a receiving device (e.g., a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

The UEs 115 and the network entities 105 may support retransmissions of data to increase the likelihood that data is received successfully. Hybrid automatic repeat request (HARQ) feedback is one technique for increasing the likelihood that data is received correctly via a communication link (e.g., a communication link 125, a D2D communication link 135). HARQ may include a combination of error detection (e.g., using a cyclic redundancy check (CRC)), forward error correction (FEC), and retransmission (e.g., automatic repeat request (ARQ)). HARQ may improve throughput at the MAC layer in poor radio conditions (e.g., low signal-to-noise conditions). In some examples, a device may support same-slot HARQ feedback, in which case the device may provide HARQ feedback in a specific slot for data received via a previous symbol in the slot. In some other examples, the device may provide HARQ feedback in a subsequent slot, or according to some other time interval.

In the wireless communications system 100, a wireless device (e.g., a UE 115, a network entity 105) may utilize PAS (which may also be referred to as probabilistic constellation shaping (PCS)) to modulate a signal. For example, transmitting and receiving devices may exchange information in the form of transport blocks (TBs), where a TB may refer to a payload passed from a MAC layer to a physical layer at a transmitting device or from a physical layer to a MAC layer at a receiving device. A transmitting device (e.g., a UE 115, a network entity 105) may modulate and encode a set of bits corresponding to (e.g., included in, assigned to) a TB using one or more distribution matchers prior to transmitting the TB (e.g., a set of modulation symbols representing the TB) to a receiving device (e.g., a UE 115, a network entity 105). For example, the one or more distribution matchers may convert the set of bits (e.g., k input bits) into a corresponding sequence of symbols (e.g., n symbols), where different symbols within a pool of possible symbols may have different associated probabilities of selection in accordance with a non-uniform probability distribution. For example, different symbols may correspond to different amplitudes (e.g., the symbols may be ASK symbols), and some amplitudes may be more likely to be included in the sequence of symbols than others based on the non-uniform probability distribution.

PAS may be used in combination with modulation schemes, such as APSK or QAM schemes, and may provide advantages when compared with other unshaped modulation types. For example, when unshaped modulation is used, each modulation symbol of a corresponding symbol constellation may be equally likely to be used and hence, over time, may be used equally often. Unshaped modulation may be based on a uniform probability distribution, as the probability of use is uniform across the different symbols of the symbol constellation. When PAS is used, however, different modulation symbols of a corresponding symbol constellation may have different probabilities of use; hence, the probability of use may be non-uniform across the different symbols of the symbol constellation. PAS may improve spectral efficiency and allow communications to more closely approach the Shannon's capacity (e.g., a theoretical maximum amount of information or data capacity that can be sent over a channel or medium). Additionally, or alternatively, PAS may improve power consumption. For example, modulation symbols with smaller amplitudes may be used more frequently than modulation symbols with larger amplitudes.

Thus, whereas an input set of k bits may be uniformly distributed, a corresponding sequence of n symbols obtained via distribution matching may be non-uniformly distributed, with some symbols more likely be to be included in the sequence of n symbols (e.g., appearing more often with the sequence) than others. A non-uniform sequence of symbols obtained via distribution matching may be converted to a corresponding bit sequence, and the corresponding bit sequence may be used for constellation mapping (e.g., mapping to the modulation symbols, such as QAM symbols, to achieve PAS). Symbols obtained via distribution matching may in some cases be referred to herein as interim symbols or shaped symbols (e.g., as opposed to modulation symbols, which may be transmitted over the air). Similarly, at a receiving device, symbols subjected to distribution dematching (which may be an inverse process with respect to distribution matching) in order to obtain a corresponding bit sequence may in some cases be referred to herein as interim symbols or shaped symbols.

Tradeoffs may exist regarding the quantity of input bits k and output symbols n associated with a distribution matching procedure. For example, the rate loss of a transmission may vary as a function of k/n. Thus, for a given probability distribution, the rate loss may decrease with an increase of n. However, encoding and decoding complexity and latency may increase with the increase of n. Additionally, compared to performing distribution matching on smaller quantities of input bits to output shorter corresponding symbol sequences (e.g., smaller k and n values), performing distribution matching on larger quantities of input bits to output longer corresponding symbol sequences (e.g., larger k and n values) may improve spectral efficiency and rate loss performance but may introduce additional latency and complexity.

Further, the quantity of output symbols n for a given TB may depend on a quantity of resource elements (REs) to which the TB may be mapped, a quantity of transmission layers via which the TB may be transmitted, a modulation order of the modulation symbols, or the like. Put another way, a block length of a distribution matcher (e.g., a quantity of symbols per sequence output by the distribution matcher) may be determined by the resources via which the TB is to be transmitted. When fewer resources are available for transmission, the block length may decrease, and rate loss may increase. Thus, for limited-resource transmissions, performance may be degraded if the block length is insufficient to avoid significant rate loss.

The techniques described herein support distribution matching across frequency bands (e.g., frequency subbands) or spatial layers and time-domain resources (e.g., symbols, slots) to obtain distribution matcher outputs with an increased block length (e.g., as compared to distribution matcher outputs that are restricted to a same frequency band or layer). A transmitting device (e.g., a UE 115, a network entity 105) may obtain a set of information bits to be transmitted to a receiving device (e.g., a UE 115, a network entity 105) via a set of time-domain resources and one or more frequency subbands or one or more layers (e.g., spatial layers). The transmitting device may configure a respective distribution matcher for each frequency subband and each layer. The transmitting device may input information bits to each distribution matcher to generate respective sets of shaped symbols.

For example, the transmitting device may input a first subset of the information bits to a first distribution matcher associated with a first frequency subband or layer and may input a second subset of the information bits to a second distribution matcher associated with a second frequency subband or layer. The first distribution matcher may output one or more sets (e.g., sequences) of shaped symbols (e.g., interim symbols) according to a first block length that is based on the first frequency subband or layer, where the block length indicates a quantity of symbols included in each set of shaped symbols (e.g., a “block” may correspond to a set of interim symbols output from a distribution matcher). The second distribution matcher may output one or more sets (e.g., sequences) of shaped symbols (e.g., interim symbols) according to a second block length that is based on the second frequency subband or layer. The first block length may be the same as or different from the second block length.

The transmitting device may concatenate outputs of the first distribution matcher with outputs of the second distribution matcher to obtain one or more sets of concatenated shaped symbols. For instance, the transmitting device may segment each set of shaped symbols (e.g., each block) output from the first distribution matcher into a first set of subblocks and may segment each set of shaped symbols (e.g., each block) output from the second distribution matcher into a second set of subblocks. The transmitting device may concatenate each subblock from the first set of subblocks with a respective subblock from the second set of subblocks to obtain one or more sets of concatenated shaped symbols. Each set of concatenated shaped symbols may thus correspond to both the first frequency band or layer and the second frequency band or layer. Further, each set of concatenated shaped symbols may be understood as a concatenated block (e.g., a block including shaped symbols output from the first distribution matcher and shaped symbols output from the second distribution matcher) and may have a block length that is greater than the first block length and greater than the second block length.

The transmitting device may perform symbol-to-bit conversion on the set(s) of concatenated shaped symbols and may input the converted bits to an encoder, such as an FEC encoder. The transmitting device may then map the encoder output to resources (e.g., the time-domain resources, frequency-domain resources corresponding to the first frequency subband and the second frequency subband, spatial-domain resources corresponding to the first layer and the second layer) allocated for transmission of a TB corresponding to the information bits. By concatenating outputs from multiple different distribution matchers, the transmitting device may avoid rate loss associated with relatively short block lengths, e.g., even if the allocated resources are limited in quantity. Accordingly, the transmitting device may apply PAS techniques when transmitting the TB to improve spectral efficiency and increase the achievable capacity of the channel without degrading performance.

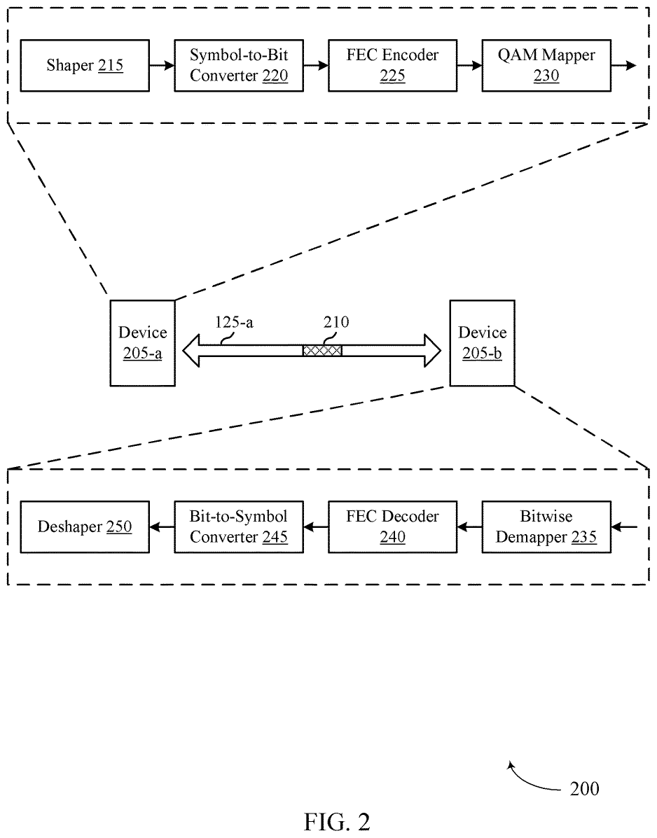

FIG. 2 illustrates an example of a wireless communications system 200 that supports resource mapping for PAS in accordance with one or more aspects of the present disclosure. In some examples, the wireless communications system 200 may implement aspects of wireless communications system 100. The wireless communications system 200 may include a device 205-a, which may include or be an example of a network entity 105, a UE 115, or any other device capable of transmitting wireless signals (e.g., as described with reference to FIG. 1). The wireless communications system 200 may also include a device 205-b, which may be an example of a network entity 105, a UE 115, or any other device capable of receiving wireless signals (e.g., as described with reference to FIG. 1).

In the example of FIG. 2, the device 205-a may operate as a transmitting device and may utilize PAS when communicating information to a receiving device, such as the device 205-b, via a communication link 125-a, which may be an example of a communication link 125 as described with reference to FIG. 1. For example, the device 205-a may process information bits of a TB 210 to obtain a corresponding set of modulation symbols. Processing the information bits may involve shaping, encoding, and modulating the information bits before mapping to a set of resources via which the TB 210 is to be transmitted. The device 205-a may transmit, via the communication link 125-a, signaling that is based on (e.g., includes or is otherwise modulated based on) the set of modulation symbols, in order to communicate the TB 210 to the device 205-b.

The information bits may be uniformly distributed. More specifically, a mapping table that maps blocks of incoming information bits to symbols to be transmitted may be configured such that a probability mass function (PMF) of symbols over constellation points of a modulation scheme is a uniform distribution. A constellation may be understood as a set of phase, frequency, and amplitude states of a signal (e.g., a signal transmitted by the device 205-a), where a constellation point represents a symbol corresponding to a phase value, a frequency value, and an amplitude value. As part of the processing, the device 205-a may shape the information bits using a shaper 215 between the source of the information bits and the mapper to constellation symbols. Probabilistic shaping, for example, may rely on the use of a code, referred to herein as a distribution matcher, to vary the probability distribution of the constellation points. As an example, the device 205-a may apply probabilistic shaping such that constellation points associated with a lower energy are more likely to be used, while constellation points associated with a higher energy are less likely to be used. Probabilistic shaping may reduce the gap (referred to as a shaping gap) between the practically achievable capacity of a channel (e.g., the communication link 125-a) and the Shannon's capacity of the channel.

In some cases, the shaper 215 may include or be an example of an amplitude shaper that maps k information bits to n amplitude symbols with a rate Rₐₛ=k/n. The amplitude shaper may be configured such that low-amplitude symbols are utilized more frequently than high-amplitude symbols, which may, in some cases, improve signal quality at the device 205-b, reduce a transmit power of the TB 210, or the like. The non-uniform distribution over the amplitude symbols generated by the amplitude shaper may be closer to the capacity-achieving input distribution than the uniform distribution.

Additionally, or alternatively, the shaper 215 may include or be an example of a shaping encoder. Here, the device 205-a may use the shaping encoder to mask the information bits and may jointly encode the shaped information bits and information for shaping. For example, the device 205-a may input information bits to a log-likelihood ratio (LLR) generator to obtain LLR values for the information bits. The device 205-a may use a channel decoder to obtain (e.g., generate) shaping bits from the LLR values. The device 205-a may generate a bitmask from the shaping bits and may apply the bitmask to the information bits to obtain shaped information bits. The device 205-a may jointly encode the shaping bits and the shaped information bits, and may map the bits to a symbol to obtain a shaped symbol.

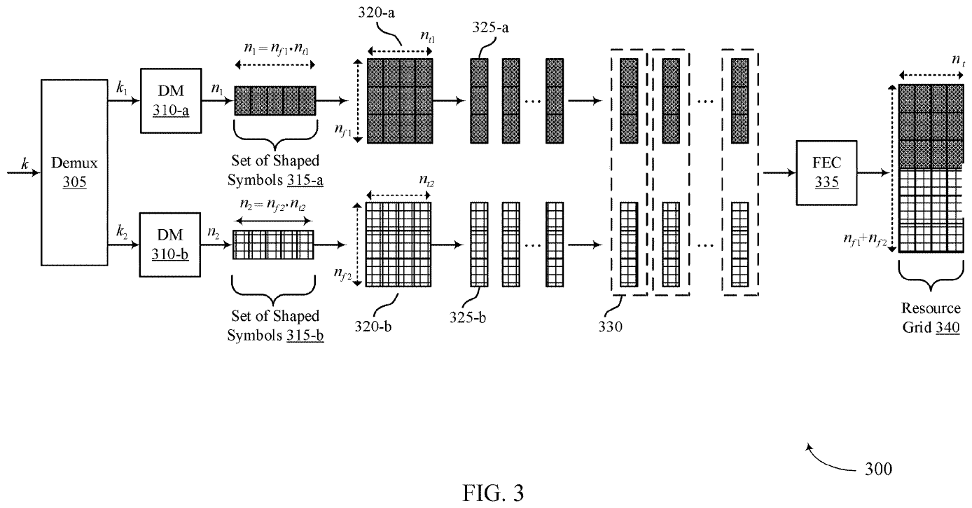

In some examples, the device 205-a may implement one or more distribution matchers to perform distribution matching as part of the shaping (e.g., as part of the shaper 215). The distribution matcher(s) may include or be examples of constant composition distribution matchers (CCDM), block code distribution matchers, or a combination thereof, among other examples. The distribution matcher(s) may perform any quantity of distribution matching procedures, each of which may accept, as an input, a uniformly distributed bit sequence (e.g., of the information bits) with length k and output a symbol sequence of length n (e.g., a sequence of n symbols) with a non-uniform probability distribution, as described in further detail with respect to FIG. 3. The non-uniform probability distribution may be, for example, a PMF. In some examples, each distribution matcher may have a respective target distribution.

In some cases, the device 205-a may divide the information bits into subsets of information bits and may perform separate distribution matching procedures on the different subsets. For example, the device 205-a may utilize (e.g., configure) a respective distribution matcher for each frequency subband or each layer associated with transmission of the TB 210, where each frequency subband or each layer may further be associated with a set of time-domain resources (e.g., symbols, slots). That is, because PAS operations are performed on frequency bands or layers with similar frequency-or spatial-domain selectivity (e.g., with similar SNR values), the device 205-a may implement PAS per layer or per frequency band/subband via the use of respective distribution matchers and target distributions.

In the example of FIG. 2, the device 205-a may implement a first distribution matcher associated with a first frequency subband of the communication link 125-a and a second distribution matcher associated with a second frequency subband of the communication link 125-a. The device 205-a may input a first subset of k₁ information bits to the first distribution matcher and may input a second subset of k₂ information bits to the second distribution matcher. The first distribution matcher may output a first one or more sets (e.g., sequences) of shaped symbols (e.g., interim symbols) according to a first block length and based on a first target distribution. Additionally, the second distribution matcher may output a second one or more sets (e.g., sequences) of shaped symbols (e.g., interim symbols) according to a second target distribution and a second block length that is based on the second frequency subband or layer. The first block length may be the same as or different from the second block length.

During distribution matching, each distribution matcher may transform k information bits into n interim symbols. For example, sequences within the k₁ input bits may each be mapped to one or more corresponding interim symbols within the n-length sequence of interim symbols. Thus, in some cases, each interim symbol may represent multiple input bits. Based on a non-uniform probability distribution associated with (e.g., used by) the first distribution matcher, different interim symbols within a pool of possible (e.g., candidate) interim symbols may not be equally likely to be included in the n-length sequence of interim symbols-that is, some interim symbols may be more likely to be included than others. In some cases, the interim symbols may be ASK symbols.

Performing distribution matching at a per-frequency-subband or per-layer level may involve the device 205-a configuring each distribution matcher with a respective set of parameters based on the corresponding frequency subband/layer and, in some cases, the corresponding target distribution. Channel quality, SNR, and other channel conditions may vary between the frequency subbands/layers, which may impact parameters to be used by a distribution matcher in order to achieve the target distribution. For example, for a Maxwell-Boltzmann target distribution, each distribution matcher may implement a different set of parameters based on the respective frequency subband. The set of parameters may include the target distribution parameters, one or more channel quality indicators (CQIs), a block length (e.g., a quantity of symbols n per sequence output by the distribution matcher), or the like, among other examples.

In some cases, block length may be associated with a frequency subband configuration, such that each distribution matcher may be configured (e.g., by the device 205-a) with a block length based on the corresponding frequency subband. That is, distribution matcher block lengths may be associated with respective bandwidth sizes, such that the device 205-a may receive signaling (e.g., control signaling) indicating a size (e.g., bandwidth) of each frequency subband and may determine the block length(s) based on the indicated size. For example, the device 205-a may receive control signaling indicating the size of the first frequency subband. The device 205-a may map the size of the first frequency subband to the first block length and may configure the first distribution matcher with the first block length. The control signaling may further indicate the size of the second frequency subband and the device 205-a may configure the second distribution matcher with the second block size accordingly.

In some cases, the control signaling may include or be an example of downlink control information (DCI), such as DCI that schedules the TB 210. For instance, the device 205-a may receive DCI that allocates resources for the TB 210 and includes an explicit indication of each frequency subband size, each distribution matcher block length, or a combination thereof. Alternatively, the frequency subband size may be implicitly associated with a bandwidth, e.g., based on the resource allocation indicated via DCI. As an example, the DCI may indicate a quantity of resource blocks (RBs) for the bandwidth, where the quantity of RBs corresponds to a frequency subband size. For instance, a quantity of RBs exceeding 160 RBs may correspond to eight frequency subbands, while 48 RBs to 160 RBs may correspond to four frequency subbands. The device 205-a may determine a frequency subband size based on the indicated quantity of RBs, and may map the frequency subband size to a distribution matcher block length. The device 205-a may configure the distribution matcher associated with the frequency subband based on the distribution matcher block length.

Additionally, or alternatively, the device 205-a may receive signaling (e.g., control signaling) indicating a set of parameters for each distribution matcher, and may configure the distribution matchers according to the indicated sets of parameters. In some cases, if the bandwidth of a frequency subband associated with a distribution matcher is relatively large, indicating the set of parameters may significantly increase signaling overhead. As such, the signaling may include a compressed indication of the set of parameters. For instance, the signaling may implement a linear model or a cubic model to represent distribution parameters (e.g., Maxwell-Boltzmann parameters). Additionally, or alternatively, the signaling may indicate one or more CQIs within the bandwidth, or one or more relative values for the CQIs across the bandwidth, and the device 205-a may configure the distribution matcher with parameters based on the indicated CQIs.

The device 205-a may segment the first one or more sets of shaped symbols output from the first distribution matcher into a first set of subblocks and may segment the second one or more sets of shaped symbols output from the second distribution matcher into a second set of subblocks. For example, as described with reference to FIG. 3, the device 205-a may segment a set of shaped symbols (e.g., a sequence) into two or more subblocks, where each subblock includes one or more shaped symbols of the set of shaped symbols. In some cases, the segmentation may be based on the size of the corresponding frequency subband. After segmenting each set of shaped symbols, the device 205-a may concatenate one or more subblocks of the first set of subblocks with one or more subblocks of the second set of subblocks. Thus, the device 205-a may obtain one or more sets of concatenated shaped symbols, where each set of concatenated shaped symbols includes shaped symbols output from the first distribution matcher and shaped symbols output from the second distribution matcher. Each set of concatenated shaped symbols may thus correspond to both the first frequency subband and the second frequency subband.

The device 205-a may input the set(s) of concatenated shaped symbols to a symbol-to-bit converter 220. The symbol-to-bit converter 220 may convert interim symbols (e.g., the set(s) of concatenated shaped symbols) into bits (e.g., a bit stream). In some cases, because the interim symbols are non-uniformly distributed, the bits output by the symbol-to-bit converter 220 may not be the same as the bits input to the first and second distribution matchers. For example, the symbol-to-bit converter 220 may output a bit sequence that includes quantity (m−1)n of bits, where m is a modulation order of the interim symbols (e.g., the quantity of different interim symbols within the pool of possible interim symbols may be equal to 2^{m}).

The device 205-a may input the converted bits to an encoder, such as an FEC encoder 225. The FEC encoder 225 may support error correction for the transmission of the TB 210 based on encoding redundancy. In some cases, the device 205-a may additionally input an unshaped subset of the information bits to the FEC encoder 225, such as a subset of γ unshaped information bits. Based on the bits input to the FEC encoder 225, the FEC encoder 225 may generate systematic bits and parity bits. For example, for every (m−1+γ) input bits, the FEC encoder 225 may generate m bits, where the extra bits may be parity bits.

The device 205-a may input the bits output from the FEC encoder 225 to a constellation mapper, which may be based on a modulation scheme according to which the device 205-a is to modulate and transmit the TB 210. That is, the device 205-a may modulate the TB 210 according to a modulation format to represent the information conveyed by the transmission. For example, OFDM modulation may be based on modulating various subcarriers (e.g., using QAM modulation) and transmitting the modulated subcarriers in parallel (e.g., concurrent) using FDM techniques. In some examples, modulation symbols may refer to symbols based on any type of modulation, such as QAM symbols, binary phase shift keying (BPSK) symbols, quadrature phase shift keying (QPSK) symbols, amplitude and phase shift keying (APSK) symbols, or the like. In the example of FIG. 2, the device 205-a may implement QAM modulation via a QAM mapper 230. The QAM mapper 230 may perform constellation mapping (e.g., map the bits input to the QAM mapper 230 to corresponding modulation symbols, based on a symbol constellation associated with the modulation symbols). A subset of the bits input to the QAM mapper 230 may be used to determine the amplitudes of the mapped-to modulation symbols, and these bits may be referred to as amplitude bits. Another subset of the bits input to the QAM mapper 230 may be used to determine the signs (e.g., polarities, phases, or both) of the mapped-to modulation symbols, and these bits may be referred to as sign bits.

Because at least a portion of the bits input to the QAM mapper 230 have been shaped, different modulation symbols within the symbol constellation used by the QAM mapper 230 may have different likelihoods of being mapped to and transmitted over the air, and thus PAS may be implemented. For example, because the amplitude bits are based on the k information bits subjected to distribution matching by the first distribution matcher and the second distribution matcher, the likelihood of a modulation symbol being mapped to may depend on the amplitude of the modulation symbol (e.g., lower amplitude modulation symbols, which may be nearer to a center of the symbol constellation, may be more likely to be mapped to than higher amplitude modulation symbols, which may be further from the center of the symbols constellation). In some cases, the device 205-a may multiply the amplitude bits with the sign bits and map the resulting products to the modulation symbols.

Modulation symbols corresponding to the TB 210 may be output by the QAM mapper 230. The device 205-a may map the modulation symbols to a set of resources for transmission via the communication link 125-a. For example, the set of resources may be those allocated (e.g., scheduled) to the device 205-a (e.g., via DCI) for transmission of the TB 210. In some cases, the device 205-a may map the modulation symbols to the set of resources according to a mapping order, such as a frequency-first, time-second ordering. Here, the device 205-a may map the modulation symbols to frequency-domain resources before mapping modulation symbols to time-domain resources. The device 205-a may then transmit the modulated symbols via the set of resources in accordance with the mapping to convey the information represented by the bits of the TB 210.

The device 205-b may receive, via the communication link 125-a, the modulation symbols corresponding to the TB 210. The device 205-b may perform a decoding operation to process the TB 210 (e.g., to obtain the bits of the TB 210 based on the corresponding modulation symbols). The decoding operation performed by the device 205-b may be an inverse of the processing procedure performed by the device 205-a. For example, the device 205-b may input the received modulation symbols to a bitwise demapper 235 to obtain a set of bits corresponding to the modulation symbols. The set of bits may include systematic bits and parity bits. The device 205-b may input the set of bits to an FEC decoder 240 to extract the information bits, after which the device 205-b may convert the information bits to symbols via a bit-to-symbol converter 245. The bit-to-symbol converter 245 may output interim symbols (e.g., shaped symbols) corresponding to the shaped symbols output by the first distribution matcher and the second distribution matcher of the device 205-a.

The device 205-b may implement a deshaper 250 to recover the original information bits transmitted by the device 205-a. The deshaper 250 may, for example, recover the shaped information and the shaping bits, and may generate a demasking vector from the shaping bits and apply the demasking vector to the shaped information bits to recover the original information bits. Additionally, the deshaper 250 may utilize one or more distribution dematching procedures. A distribution dematching procedure may accept, from the bit-to-symbol converter 245, an input sequence of interim symbols (e.g., n interim symbols) and output a corresponding set of bits (e.g., k bits). To perform distribution dematching, the device 205-b may include any quantity of distribution dematchers, which may, in some cases, be equal to the quantity of distribution matchers of the device 205-a. That is, the device 205-b may implement a respective distribution dematcher for each frequency subband or layer via which the TB 210 is received, which may be equal to the quantity of distribution matchers utilized by the device 205-a for transmitting the TB 210. In any case, the device 205-b may perform distribution dematching to obtain the original information bits from the set of interim symbols.

FIG. 3 illustrates an example of an encoding process 300 that supports resource mapping for PAS in accordance with one or more aspects of the present disclosure. In some examples, encoding process 300 may be implemented by aspects of wireless communications system 100 and wireless communications system 200. For example, a transmitting device (e.g., a device 205-a) may encode a message for transmission to a receiving device (e.g., a device 205-b) using PAS according to encoding process 300. The transmitting device may implement the encoding process 300 to perform cross-frequency-domain and cross-time-domain distribution matching and resource mapping in accordance with the techniques described herein. In some examples, the receiving device may perform a decoding operation comprising inverse operations corresponding to the operations of encoding process 300.

The encoding process 300 may include several stages by which the transmitting device processes a set of k information bits (e.g., corresponding to a TB) for transmission to the receiving device. In some examples, the transmitting device may transmit a TB as a set of CBs, where each CB may correspond to a portion of the information bits of the TB. In such examples, the transmitting device may process each CB individually according to the encoding process 300.

The encoding process 300 may include, for example, distribution matching, block segmentation, subblock concatenation, FEC, and resource mapping. Additionally, it is to be understood that the encoding process 300 is for illustrative purposes, and that some stages may be removed or additional stages may be included, such as attaching one or more CRC bits, low-density parity-check code (LDPC) encoding, and constellation mapping (e.g., mapping bits or groups of bits to corresponding modulation symbols), among other possible stages.

The transmitting device may obtain the set of k information bits to be transmitted to the receiving device. In some cases, the transmitting device may determine a set of resources (e.g., time-domain resources, frequency-domain resources) via which the information bits are to be transmitted. For example, the transmitting device may receive control signaling scheduling transmission of the information bits, where the control signaling indicates the set of resources allocated for the transmission. After obtaining the set of k information bits, the transmitting device may partition the k information bits into two or more subsets via a demultiplexer 305. In the example of FIG. 3, the demultiplexer 305 may output a first subset of information bits and a second subset of information bits. The quantity of bits included in the first subset of bits may be represented by k₁ and the quantity of bits included in the second subset of bits may be represented by k₂ (e.g., k=k₁+k₂).

The transmitting device may utilize one or more distribution matchers, such as a distribution matcher 310-a and a distribution matcher 310-b, as part of the encoding process 300. Each distribution matcher 310 may be an example of a distribution matcher described with reference to FIG. 2 and may correspond to a respective subband or layer, for example, based on the set of resources allocated for the transmission. Further, each distribution matcher 310 may be configured (e.g., by the transmitting device) according to a respective set of parameters (e.g., based on the corresponding subband or layer). That is, because the distribution matcher 310-a and the distribution matcher 310-b correspond to different frequency subbands, the distribution matcher 310-a and the distribution matcher 310-b may have different configurations. For example, the distribution matcher 310-a may operate according to a first block length (e.g., a quantity of symbols per sequence output by the distribution matcher 310-a) based on a size of a first frequency subband associated with the distribution matcher 310-a. The distribution matcher 310-a may implement a first target distribution (e.g., probability distribution). The distribution matcher 310-b may operate according to a second block length based on a size of a second frequency subband associated with the distribution matcher 310-b, and may implement a second target distribution. In some examples, the first block length and the second block length may be based on a quantity of time-domain resources nₜ and a quantity of frequency-domain resources n_{f} of the set of resources.

The transmitting device may partition the k information bits into the first and second subsets in order to input each subset of information bits into a different distribution matcher 310. In some examples, the values of k₁ and k₂ may depend on the first block length of the first distribution matcher 310-a and the second block length of the distribution matcher 310-b, respectively. For instance, the first subset of information bits may be input to the distribution matcher 310-a, which may transform the k₁ information bits into a first set of interim symbols. As discussed herein, interim symbols may be referred to or understood as shaped symbols, and a set of shaped symbols (e.g., a set of interim symbols) may be referred to or understood as a sequence (e.g., of interim symbols), a block, or the like. The quantity of interim symbols within the first set of interim symbols may be represented by n₁ (e.g., the first set of interim symbols may include n₁ interim symbols).

During distribution matching, sequences of bits within the k₁ input bits may each be mapped to one or more corresponding interim symbols within the n₁-length sequence of interim symbols. The n₁ interim symbols output from the distribution matcher 310-a may be referred to as a first set of shaped symbols (e.g., a set of shaped symbols 315-a) and may correspond to the first subset of information bits. The k₂ information bits may be input to the distribution matcher 310-b, which may output n₂ interim symbols corresponding to the second subset of information bits. The n₂ interim symbols may be referred to as a second set of shaped symbols (e.g., a set of shaped symbols 315-b). Although FIG. 3 illustrates a single set of n symbols output from each distribution matcher 310, it is to be understood that the encoding process 300 may be applied to any quantity of sets of symbols output from any quantity of distribution matchers.

In some cases, the quantity of symbols n included in each set of shaped symbols 315 may be based on the quantity of time-domain resources nₜ and the quantity of frequency-domain resources n_{f} allocated for the transmission and on the associated frequency subband size. For example, the set of shaped symbols 315-a may include n₁ shaped symbols based on a first subset nₜ₁ of the time-domain resources and a first subset n_{f1} of the frequency-domain resources, where n₁=n_{f1}*nₜ₁. That is, the quantity n₁ of shaped symbols within the set of shaped symbols 315-a may be based on a product of the quantity of time-domain resources of the first subset of time-domain resources and the quantity of frequency-domain resources of the first subset of frequency-domain resources. Additionally, the quantity of frequency-domain resources of the first subset n_{f1} may be determined based on the size of the first frequency subband. Put another way, within the set of allocated frequency resources n_{f}, the first frequency subband may have n_{f1} frequency-domain resources in accordance with the size of the first frequency subband.

Similarly, the set of shaped symbols 315-b may include n₂ shaped symbols based on a second subset nₜ₂ of the time-domain resources and a second subset n_{f2} of the frequency-domain resources, where n₂=n_{f2}*nₜ₂ and n_{f}=n_{f1}+n_{f2}, and where the n_{f2} frequency-domain resources are based on the size of the second frequency subband. In some cases, the first subset of the time-domain resources may be equal to the second subset of the time-domain resources, such that nₜ₁=nₜ₂, though in other cases, nₜ₁ and nₜ₂ may be different.

To perform the cross-domain (e.g., cross-frequency-domain and cross-time-domain) distribution matching and resource mapping, the transmitting device may segment the outputs of each distribution matcher 310 based on the first and second frequency subband sizes (e.g., based on n_{f1} and n_{f2}), respectively. The transmitting device may transform the set of shaped symbols 315-a into a set of nₜ₁ time blocks and n_{f1} frequency blocks in a time-frequency matrix representation 320-a of a resource grid. That is, the transmitting device may map the set of shaped symbols 315-a to the time-frequency matrix representation 320-a, where the time-frequency matrix representation 320-a has dimensions nₜ₁ (e.g., on the x-axis) by n_{f1} (e.g., on the y-axis). The transmitting device may transform the set of shaped symbols 315-b into a set of nₜ₂ time blocks and n_{f2} frequency blocks in a time-frequency matrix representation 320-b of the resource grid.

Based on the mapping, the transmitting device may segment the time-frequency matrix representation 320-a into a set of subblocks 325-a and may segment the time-frequency matrix representation 320-b into a set of subblocks 325-b. In some cases, the transmitting device may segment the time-frequency matrix representations 320 per time duration (e.g., per time-domain resource or per a portion of a time-domain resource), for example, based on the time duration according to which the transmitting device is to perform FEC. In the example of FIG. 3, the segmentation is performed per time symbol, such that each subblock 325 may correspond to one time-domain symbol of the set of time-domain resources. Thus, the time-frequency matrix representation 320-a may be segmented into a quantity nₜ₁ of subblocks 325-a, and each subblock 325-a may have a length equal to n_{f1} (e.g., may include n_{f1} shaped symbols output from the distribution matcher 310-a). Likewise, the time-frequency matrix representation 320-b may be segmented into a quantity nₜ₂ of subblocks 325-b, and each subblock 325-b may have a length n_{f2} (e.g., may include n_{f2} shaped symbols output from the distribution matcher 310-b).

The transmitting device may concatenate segments of outputs from each distribution matcher 310. For example, the transmitting device may concatenate one or more subblocks 325-a with one or more subblocks 325-b to obtain one or more sets of concatenated shaped symbols 330. Each set of concatenated shaped symbols 330 may include a quantity of shaped symbols equal to n_{f1}+n_{f2}, which may be understood as a combined block length. Moreover, each set of concatenated shaped symbols 330 may be associated with the first frequency subband and the second frequency subband, as each set of concatenated shaped symbols 330 includes shaped symbols output from the distribution matcher 310-a and shaped symbols output from the distribution matcher 310-b.

The transmitting device may perform FEC encoding on each set of concatenated shaped symbols 330 via an FEC encoder 335, such that the FEC encoding is performed across the frequency domains of the first frequency subband and the second frequency subband. Each set of concatenated shaped symbols 330 may be considered a pre-FEC block. In some cases, the transmitting device may, prior to FEC encoding, input each set of concatenated shaped symbols 330 to a symbol-to-bit converter to convert the shaped symbols to bits, and may input the converted bits to the FEC encoder 335. Additionally, or alternatively, the transmitting device may input unshaped information bits from the set of information bits to the FEC encoder 335, e.g., together with the shaped symbols or the converted bits. The FEC encoder 335 may generate and output a set of encoding bits, which may include parity bits and systematic bits, corresponding to the set of information bits.

In some examples, the transmitting device may input the bits output from the FEC encoder 335 to a constellation mapper, which may perform constellation mapping (e.g., map the bits input to the constellation mapper to corresponding modulation symbols based on a symbol constellation associated with the modulation symbols). A subset of the bits input to the constellation mapper may be used to determine the amplitudes of the mapped-to modulation symbols, and these bits may be referred to as amplitude bits. Another subset of the bits input to the constellation mapper may be used to determine the signs (e.g., polarities, phases, or both) of the mapped-to modulation symbols, and these bits may be referred to as sign bits. In some cases, the transmitting device may multiply the amplitude bits with the sign bits and map the resulting products to the modulation symbols.

After encoding (and, in some cases, constellation mapping), the transmitting device may map the sets of concatenated shaped symbols output from the FEC encoder 335 to the set of resources according to a resource mapping scheme. The resource mapping scheme may include an ordering by which the transmitting device assigns resources of the set of resources. The set of resources may be represented by a resource grid 340 that includes nₜ time-domain resources (e.g., because nₜ₁=nₜ₂) and n_{f}=n_{f1}+n_{f2} frequency-domain resources. The transmitting device may map shaped symbols of the sets of concatenated shaped symbols to the resource grid in a frequency-first, time-second ordering. For instance, the transmitting device may map a first symbol to a first frequency resource and a first time resource, a second symbol to a second frequency resource and the first time resource, a third symbol to a third frequency resource and the first time resource, and so on, up to the nₜ^{th} time resource. In some cases, the resource grid 340 may further include multiple layers, and the resource mapping may be performed according to a layer-first, frequency-second, time-third ordering.

The transmitting device may transmit the shaped symbols corresponding to the set of information bits via the set of resources. The receiving device may perform a decoding operation comprising inverse operations corresponding to the operations of encoding process 300 to obtain the set of information bits.

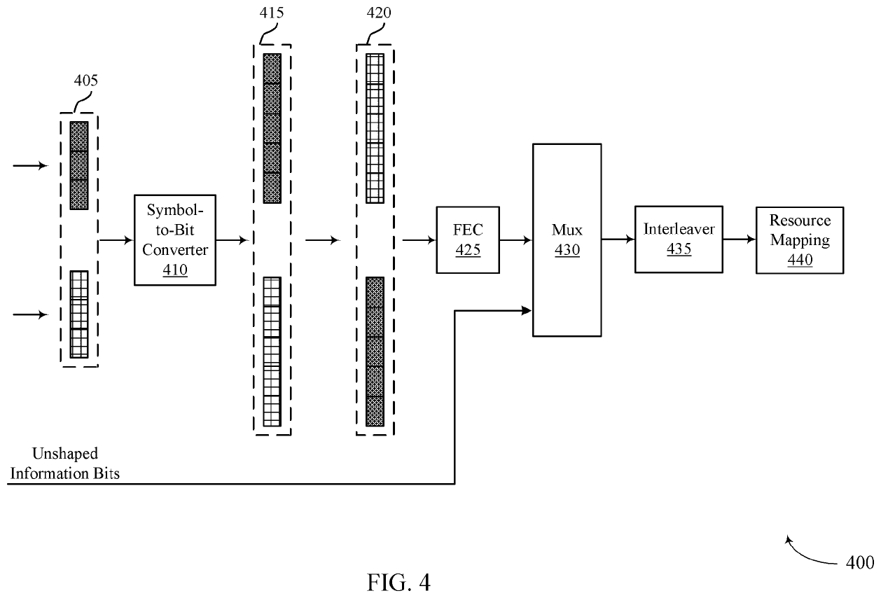

FIG. 4 illustrates an example of an encoding process 400 that supports resource mapping for PAS in accordance with one or more aspects of the present disclosure. In some examples, the encoding process 400 may be implemented by aspects of wireless communications system 100 and wireless communications system 200. For example, a transmitting device (e.g., a device 205-a) may encode a message for transmission to a receiving device (e.g., a device 205-b) using PAS according to the encoding process 400. The encoding process 400 may occur as part of an encoding process 300. That is, the encoding process 400 illustrates additional stages of processing that may be added to the encoding process 300, by which the transmitting device processes a set of k information bits (e.g., corresponding to a TB) for transmission to the receiving device via a set of resources (e.g., time-frequency resources).

For example, though not illustrated, the encoding process 400 may include, as described with reference to FIG. 3, a demultiplexer 305 and two (or more) distribution matchers 310, and the transmitting device may map outputs of the distribution matchers 310 to respective time-frequency matrix representations 320. The transmitting device may segment each time-frequency matrix representation 320 into a first set of subblocks 325-a and a second set of subblocks 325-b. The transmitting device may concatenate a first subblock of the first set of subblocks with a second subblock of the second set of subblocks to obtain a set of concatenated shaped symbols 405. Thus, the encoding process 400 as illustrated in FIG. 4 may begin after the transmitting device has concatenated shaped symbols output from respective distribution matchers. Further, although FIG. 4 illustrates an example of one set of concatenated shaped symbols 405, the techniques described herein may be applied to any quantity of concatenated shaped symbols 405.

The transmitting device may input the set of concatenated shaped symbols 405 to a symbol-to-bit converter 410 to obtain a bit stream 415 of shaped bits corresponding to the shaped symbols. For example, as discussed with reference to FIG. 3, the symbol-to-bit converter 410 may output a bit sequence (e.g., a bit stream 415) that includes a quantity (m−1)n of bits, where n is the quantity of shaped symbols included in the set of concatenated shaped symbols 405 and m is a modulation order of the shaped symbols. The bit stream 415 may include bits associated with each subband (e.g., the first frequency subband and the second frequency subband discussed with reference to FIG. 3).

The transmitting device may perform a pre-FEC interleaving operation on the bit stream 415 to obtain an interleaved bit stream 420. In some examples, the pre-FEC interleaving operation may be performed according to a subband- or RB-level interleaving, where bits of the bit stream 415 that correspond to different subbands (or RBs) are interleaved based on the subbands. In the example of FIG. 4, bits corresponding to the first frequency subband may be interleaved, within the bit stream 420, with bits corresponding to the second frequency subband. In other examples, more than two frequency subbands may be associated with the encoding process 400. In such examples, the bit stream 415 may include one or more bits associated with the first frequency subband (represented by s₁), one or more bits associated the second frequency subband (represented by s₂), one or more bits associated a third frequency subband (represented by s₃), and one or more bits associated a fourth frequency subband (represented by s₄). Prior to interleaving, the bits may be ordered within the bit stream 415 according to the respective frequency subbands, e.g., [s₁, s₂, s₃, s₄]. The bit stream 415 may be input to a subband-level interleaver, which may output the interleaved bit stream 420; bits within the bit stream 420 may be ordered according to [s₃, s₂, s₄, s₁]. Similar techniques may be applied per RB for an RB-level interleaver.

Additionally, or alternatively, for more than one set of concatenated shaped symbols 405, the transmitting device may perform pre-FEC interleaving across sets of concatenated shaped symbols 405. For instance, the transmitting device may input two (or more) sets of concatenated shaped symbols 405 to the symbol-to-bit converter 410 to obtain a first bit stream and a second bit stream. The transmitting device may interleave the first bit stream and the second bit stream, e.g., based on the first frequency subband and the second frequency subband (e.g., according to a subband-level interleaver), to obtain the interleaved bit stream 420.

The transmitting device may input the interleaved bit stream 420 to an FEC encoder 425 to provide redundancy. In some cases, the transmitting device may additionally input a subset of unshaped information bits to the FEC encoder 425, e.g., together with the shaped symbols or the converted bits. The FEC encoder 425 may generate and output a set of encoding bits, which may include parity bits and systematic bits, based on each set of concatenated shaped symbols 405 and, if applicable, based on the subset of unshaped information bits.

After FEC encoding, the transmitting device may multiplex the parity bits output from the FEC encoder with one or more unshaped information bits of the set of information bits using a multiplexer 430 (e.g., a multiplexing operation). The output of the multiplexer 430 may be a set of multiplexed bits that includes shaped bits and unshaped bits. In some cases, the transmitting device may perform post-FEC interleaving (e.g., may implement a post-FEC interleaver 435) within the set of multiplexed bits. The post-FEC interleaving may be performed according to a subband- or RB-level interleaving, where bits of the set of multiplexed bits that correspond to different subbands (or RBs) are interleaved based on the subbands. In some examples, the unshaped information bits multiplexed and, in some cases, interleaved, with the shaped bits may be referred to as sign bits.

In some cases, the transmitting device may perform constellation mapping after the post-FEC interleaver 435 based on the shaped bits. The transmitting device may map the shaped bits input to the constellation mapper to corresponding modulation symbols based on a symbol constellation associated with the modulation symbols. For example, the transmitting device may perform constellation mapping such that the amplitudes of modulation symbols are based on the shaped bits, and the signs of the modulation symbols are based on the unshaped second subset of bits. In some cases, the transmitting device may multiply the amplitude bits with the sign bits and map the resulting products to the modulation symbols.

After encoding (and, in some cases, constellation mapping), the transmitting device may map the interleaved, multiplexed bits to the set of time-frequency resources according to a resource mapping 440. The resource mapping 440 may include an ordering by which the transmitting device assigns resources of the set of resources. For example, the transmitting device may map bits of the interleaved, multiplexed bits to the resource grid in a frequency-first, time-second ordering. In cases where the transmitting device performs constellation mapping, the transmitting device may map the modulation symbols to the set of time-frequency resources based on the ordering. The transmitting device may transmit the bits (e.g., modulation symbols) corresponding to the set of information bits via the set of resources. The receiving device may perform a decoding operation comprising inverse operations corresponding to the operations of encoding process 400 to obtain the set of information bits.

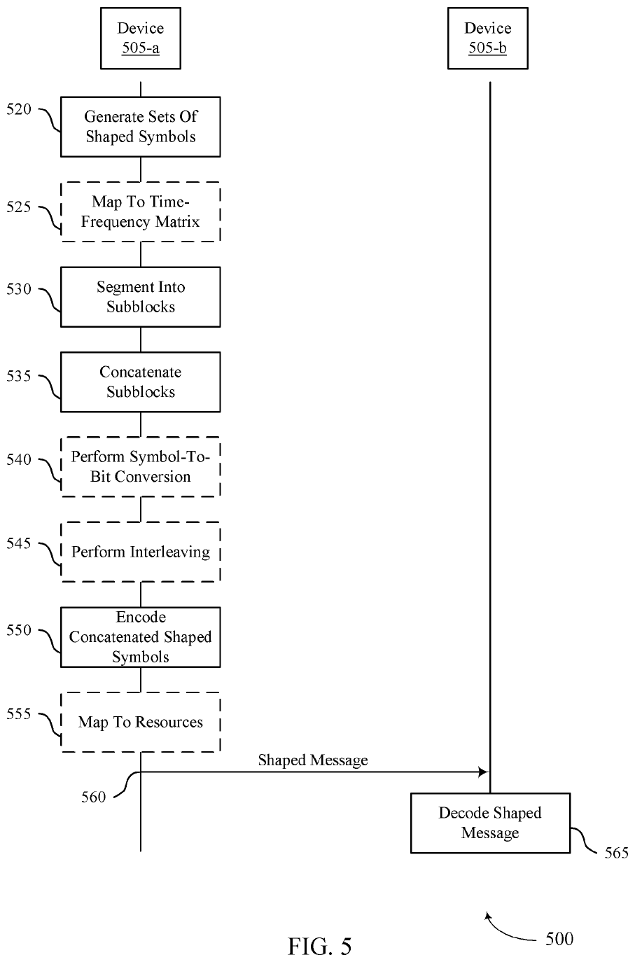

FIG. 5 illustrates an example of a process flow 500 that supports resource mapping for PAS in accordance with one or more aspects of the present disclosure. In some examples, the process flow 500 may be implemented by aspects of the wireless communications system 100 or the wireless communications system 200. For example, the process flow 500 may be an example of a device 505-a (e.g., a transmitting device) encoding a message for transmission to a device 505-b (e.g., a receiving device) as discussed herein. The process flow 500 may include aspects of the encoding process 300, the encoding process 400, or any combination thereof. In some examples, the device 505-b may perform a decoding operation comprising inverse operations corresponding to the operations of the process flow 500. The process flow 500 may be an example of a process flow in which each distribution matching procedure corresponds to a respective frequency subband.

At 520, the device 505-a may obtain a set of information bits to be transmitted to the device 505-b. In some examples, the set of information bits may be scheduled for transmission via a set of time-frequency resources of a channel. The device 505-a may generate sets of shaped symbols corresponding to respective subsets of information bits of the set of information bits using two or more distribution matchers, where each distribution matcher is associated with a respective frequency subband or a respective layer. For example, the device 505-a may generate, using a first distribution matcher of the device 505-a, a first set of shaped symbols corresponding to a first subset of the set of information bits. The first distribution matcher may be associated with a first frequency subband and a block size of the first distribution matcher may be based on a size of the first frequency subband. The device 505-a may generate, using a second distribution matcher of the device 505-a, a second set of shaped symbols corresponding to a second subset of the set of information bits. The second distribution matcher may be associated with a second frequency subband different from the first frequency subband, and a block size of the second distribution matcher may be based on a size of the second frequency subband.

In some examples, the device 505-a may receive a signal (e.g., control signaling, such as DCI) indicating the size of the first frequency subband and the size of the second frequency subband. In some cases, the size of the first frequency subband and the size of the second frequency subband may be based on a bandwidth. In some examples, the signal may further indicate one or more parameters for the first distribution matcher, one or more parameters for the second distribution matcher, or a combination thereof. The device 505-a may configure the first distribution matcher and the second distribution matcher based on the corresponding block size, frequency subband size, and set of parameters.

At 525, the device 505-a may map the first set of shaped symbols to a first time-frequency matrix representation of a resource grid associated with the set of time-frequency resources (e.g., allocated for the transmission). The first time-frequency matrix representation may correspond to a first quantity of frequency-domain resources of the set of time-frequency resources and a first quantity of time-domain resources of the set of time-frequency resources. In some examples, the first quantity of frequency-domain resources may be based on a size of the first frequency subband.

Additionally, at 525, the device 505-a may map the second set of shaped symbols to a second time-frequency matrix representation of the resource grid. The second time-frequency matrix representation may correspond to a second quantity of frequency-domain resources of the set of time-frequency resources and a second quantity of time-domain resources of the set of time-frequency resources.

At 530, the device 505-a may segment the first set of shaped symbols into a first set of subblocks, such that each subblock of the first set of subblocks includes a respective subset of shaped symbols of the first set of shaped symbols. The device 505-a may segment the second set of shaped symbols into a second set of subblocks. Each subblock of the second set of subblocks may include a respective subset of shaped symbols of the second set of shaped symbols.

In some examples, at 530, the device 505-a may segment the first set of shaped symbols and the second set of shaped symbols based on the first time-frequency matrix representation and the second time-frequency matrix representation, respectively (e.g., based on mapping the first and second sets of shaped symbols to the first and second time-frequency matrix representations at 525). For example, the device 505-a may segment the first set of shaped symbols into the first set of subblocks such that the first set of subblocks includes a first quantity of subblocks, where the first quantity of subblocks is based on or otherwise associated with the first quantity of time-domain resources. Additionally, the device 505-a may segment the second set of shaped symbols into the second set of subblocks to obtain a second quantity of subblocks that is based on or otherwise associated with the second quantity of time-domain resources.

At 535, the device 505-a may concatenate one or more subblocks of the first set of subblocks with one or more subblocks of the second set of subblocks to obtain one or more sets of concatenated shaped symbols. Each set of concatenated shaped symbols may include at least a first subblock of the first set of subblocks and at least a second subblock of the second set of subblocks, and may be associated with the first frequency subband and the second frequency subband. In some examples, a quantity of shaped symbols of each set of concatenated shaped symbols may be equal to a sum of the first quantity of frequency-domain resources and the second quantity of frequency-domain resources.

For example, the device 505-a may concatenate a first subblock of the first set of subblocks with a second subblock of the second set of subblocks to obtain a first set of concatenated shaped symbols. Additionally, the device 505-a may concatenate a third subblock of the first set of subblocks with a fourth subblock of the second set of subblocks to obtain a second set of concatenated shaped symbols.

At 540, in some examples, the device 505-a may perform a symbol-to-bit conversion operation on each set of concatenated shaped symbols to obtain a respective set of bit streams. For example, the device 505-a may perform a first symbol-to-bit conversion operation on the first set of concatenated shaped symbols to obtain a first bit stream. In some cases, the device 505-a may additionally perform a second symbol-to-bit conversion operation on the second set of concatenated shaped symbols to obtain a second bit stream.

At 545, in some examples, the device 505-a may perform one or more interleaving operations. In some cases, the interleaving operations may be performed via frequency subband interleavers, RB interleavers, or the like. Additionally, or alternatively, the device 505-a may perform interleaving within a bit stream or across bit streams. For example, the device 505-a may interleave bits of the first bit stream within the first bit stream (e.g., based on the first frequency subband and the second frequency subband) to obtain an interleaved bit stream. In some cases, the device 505-a may interleave the first bit stream and the second bit stream based on the first frequency subband and the second frequency subband to obtain the interleaved bit stream.

At 550, the device 505-a may encode the one or more sets of concatenated shaped symbols. For example, if the device 505-a performed symbol-to-bit conversion at 540, the device 505-a may input converted bits (e.g., bit stream(s)) corresponding to the one or more sets of concatenated shaped symbols to an encoder of the device 505-a, such as an FEC encoder. Additionally, if the device 505-a performed interleaving at 540, the device 505-a may input the interleaved bit stream to the encoder, where the interleaved bit stream corresponds to the one or more sets of concatenated shaped symbols. In some examples, encoding the one or more sets of concatenated shaped symbols may include generating a set of parity bits based on the one or more sets of concatenated shaped symbols.

In some cases, at 550, the device 505-a may perform one or more multiplexing operations, one or more interleaving operations (e.g., in addition to or instead of the interleaving operation(s) performed at 545), or a combination thereof. For example, the device 505-a may multiplex the set of parity bits with one or more unshaped information bits of the set of information bits to obtain a set of multiplexed bits. The device 505-a may, in some cases, interleave multiplexed bits of the set of multiplexed bits based on the first frequency subband and the second frequency subband.

At 555, the device 505-a may map the sets of concatenated shaped symbols, or the bits corresponding to the sets of concatenated shaped symbols, to the set of time-frequency resources. For example, the device 505-a may map the sets of concatenated shaped symbols to the set of resources based on a frequency-first, time-second ordering.

At 560, the device 505-a may transmit, and the device 505-b may receive, a shaped message via the set of resources based on the encoding and the resource mapping. The shaped message may include the one or more sets of concatenated shaped symbols.

At 565, the device 505-b may decode the shaped message. For example, the device 505-b may perform a decoding operation comprising inverse operations corresponding to the operations of the process flow 500.

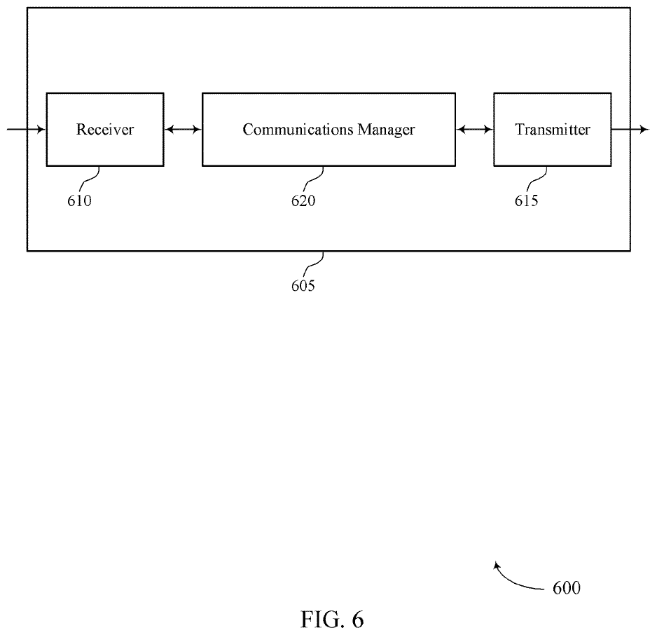

FIG. 6 illustrates a block diagram 600 of a device 605 that supports resource mapping for PAS in accordance with one or more aspects of the present disclosure. The device 605 may be an example of aspects of a UE 115 or a network entity 105 as described herein. The device 605 may include a receiver 610, a transmitter 615, and a communications manager 620. The device 605 may also include a processor. Each of these components may be in communication with one another (e.g., via one or more buses).

The receiver 610 may provide a means for receiving information such as packets, user data, control information, or any combination thereof associated with various information channels (e.g., control channels, data channels, information channels related to resource mapping for PAS). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to resource mapping for PAS). In some examples, the transmitter 615 may be co-located with a receiver 610 in a transceiver module. The transmitter 615 may utilize a single antenna or a set of multiple antennas.

The communications manager 620, the receiver 610, the transmitter 615, or various combinations thereof or various components thereof may be examples of means for performing various aspects of resource mapping for PAS as described herein. For example, the communications manager 620, the receiver 610, the transmitter 615, or various combinations or components thereof may support a method for performing one or more of the functions described herein.

In some examples, the communications manager 620, the receiver 610, the transmitter 615, or various combinations or components thereof may be implemented in hardware (e.g., in communications management circuitry). The hardware may include a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 620, the receiver 610, the transmitter 615, or various combinations or components thereof may be implemented in code (e.g., as communications management software or firmware) executed by a processor. If implemented in code executed by a processor, the functions of the communications manager 620, the receiver 610, the transmitter 615, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 620 may be configured to perform various operations (e.g., receiving, obtaining, monitoring, outputting, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to obtain information, output information, or perform various other operations as described herein.

The communications manager 620 may support wireless communications at a wireless device in accordance with examples as disclosed herein. For example, the communications manager 620 may be configured as or otherwise support a means for generating, using a first distribution matcher of the wireless device, a first set of shaped symbols corresponding to a first subset of a set of information bits, the first distribution matcher associated with a first frequency subband. The communications manager 620 may be configured as or otherwise support a means for generating, using a second distribution matcher of the wireless device, a second set of shaped symbols corresponding to a second subset of the set of information bits, the second distribution matcher associated with a second frequency subband. The communications manager 620 may be configured as or otherwise support a means for segmenting the first set of shaped symbols into a first set of subblocks, where each subblock of the first set of subblocks includes a respective subset of the first set of shaped symbols. The communications manager 620 may be configured as or otherwise support a means for segmenting the second set of shaped symbols into a second set of subblocks, where each subblock of the second set of subblocks includes a respective subset of the second set of shaped symbols. The communications manager 620 may be configured as or otherwise support a means for concatenating a first subblock of the first set of subblocks with a second subblock of the second set of subblocks to obtain a first set of concatenated shaped symbols, where the first set of concatenated shaped symbols is associated with the first frequency subband and the second frequency subband. The communications manager 620 may be configured as or otherwise support a means for transmitting a message including at least the first set of concatenated shaped symbols.

By including or configuring the communications manager 620 in accordance with examples as described herein, the device 605 (e.g., a processor controlling or otherwise coupled with the receiver 610, the transmitter 615, the communications manager 620, or a combination thereof) may support techniques for a transmitting device, such as a network entity 105 or a UE 115, to perform distribution matching across time-domain and frequency-domain resources to obtain a bit sequence with a non-uniform probability distribution prior to constellation mapping, which may yield reduced processing, reduced power consumption, more efficient utilization of communication resources, and the like.

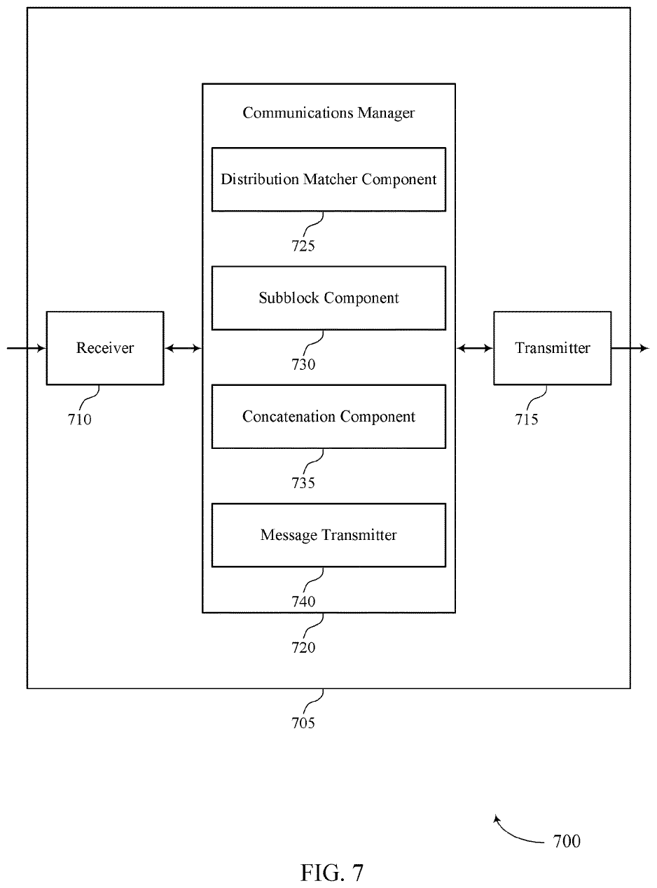

FIG. 7 illustrates a block diagram 700 of a device 705 that supports resource mapping for PAS in accordance with one or more aspects of the present disclosure. The device 705 may be an example of aspects of a device 605, a UE 115, or a network entity 105 as described herein. The device 705 may include a receiver 710, a transmitter 715, and a communications manager 720. The device 705 may also include a processor. Each of these components may be in communication with one another (e.g., via one or more buses).

The receiver 710 may provide a means for receiving information such as packets, user data, control information, or any combination thereof associated with various information channels (e.g., control channels, data channels, information channels related to resource mapping for PAS). Information may be passed on to other components of the device 705. The receiver 710 may utilize a single antenna or a set of multiple antennas.

The transmitter 715 may provide a means for transmitting signals generated by other components of the device 705. For example, the transmitter 715 may transmit information such as packets, user data, control information, or any combination thereof associated with various information channels (e.g., control channels, data channels, information channels related to resource mapping for PAS). In some examples, the transmitter 715 may be co-located with a receiver 710 in a transceiver module. The transmitter 715 may utilize a single antenna or a set of multiple antennas.

The device 705, or various components thereof, may be an example of means for performing various aspects of resource mapping for PAS as described herein. For example, the communications manager 720 may include a distribution matcher component 725, a subblock component 730, a concatenation component 735, a message transmitter 740, or any combination thereof. The communications manager 720 may be an example of aspects of a communications manager 620 as described herein. In some examples, the communications manager 720, or various components thereof, may be configured to perform various operations (e.g., receiving, obtaining, monitoring, outputting, transmitting) using or otherwise in cooperation with the receiver 710, the transmitter 715, or both. For example, the communications manager 720 may receive information from the receiver 710, send information to the transmitter 715, or be integrated in combination with the receiver 710, the transmitter 715, or both to obtain information, output information, or perform various other operations as described herein.

The communications manager 720 may support wireless communications at a wireless device in accordance with examples as disclosed herein. The distribution matcher component 725 may be configured as or otherwise support a means for generating, using a first distribution matcher of the wireless device, a first set of shaped symbols corresponding to a first subset of a set of information bits, the first distribution matcher associated with a first frequency subband. The distribution matcher component 725 may be configured as or otherwise support a means for generating, using a second distribution matcher of the wireless device, a second set of shaped symbols corresponding to a second subset of the set of information bits, the second distribution matcher associated with a second frequency subband. The subblock component 730 may be configured as or otherwise support a means for segmenting the first set of shaped symbols into a first set of subblocks, where each subblock of the first set of subblocks includes a respective subset of the first set of shaped symbols. The subblock component 730 may be configured as or otherwise support a means for segmenting the second set of shaped symbols into a second set of subblocks, where each subblock of the second set of subblocks includes a respective subset of the second set of shaped symbols. The concatenation component 735 may be configured as or otherwise support a means for concatenating a first subblock of the first set of subblocks with a second subblock of the second set of subblocks to obtain a first set of concatenated shaped symbols, where the first set of concatenated shaped symbols is associated with the first frequency subband and the second frequency subband. The message transmitter 740 may be configured as or otherwise support a means for transmitting a message including at least the first set of concatenated shaped symbols.

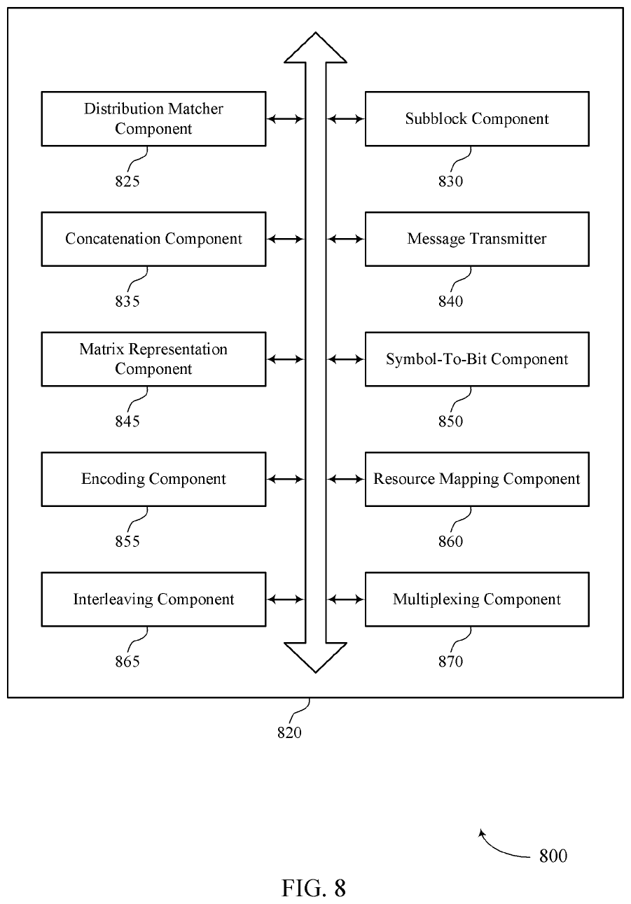

FIG. 8 illustrates a block diagram 800 of a communications manager 820 that supports resource mapping for PAS in accordance with one or more aspects of the present disclosure. The communications manager 820 may be an example of aspects of a communications manager 620, a communications manager 720, or both, as described herein. The communications manager 820, or various components thereof, may be an example of means for performing various aspects of resource mapping for PAS as described herein. For example, the communications manager 820 may include a distribution matcher component 825, a subblock component 830, a concatenation component 835, a message transmitter 840, a matrix representation component 845, a symbol-to-bit component 850, an encoding component 855, a resource mapping component 860, an interleaving component 865, a multiplexing component 870, or any combination thereof. Each of these components may communicate, directly or indirectly, with one another (e.g., via one or more buses) which may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 820 may support wireless communications at a wireless device in accordance with examples as disclosed herein. The distribution matcher component 825 may be configured as or otherwise support a means for generating, using a first distribution matcher of the wireless device, a first set of shaped symbols corresponding to a first subset of a set of information bits, the first distribution matcher associated with a first frequency subband. In some examples, the distribution matcher component 825 may be configured as or otherwise support a means for generating, using a second distribution matcher of the wireless device, a second set of shaped symbols corresponding to a second subset of the set of information bits, the second distribution matcher associated with a second frequency subband. The subblock component 830 may be configured as or otherwise support a means for segmenting the first set of shaped symbols into a first set of subblocks, where each subblock of the first set of subblocks includes a respective subset of the first set of shaped symbols. In some examples, the subblock component 830 may be configured as or otherwise support a means for segmenting the second set of shaped symbols into a second set of subblocks, where each subblock of the second set of subblocks includes a respective subset of the second set of shaped symbols. The concatenation component 835 may be configured as or otherwise support a means for concatenating a first subblock of the first set of subblocks with a second subblock of the second set of subblocks to obtain a first set of concatenated shaped symbols, where the first set of concatenated shaped symbols is associated with the first frequency subband and the second frequency subband. The message transmitter 840 may be configured as or otherwise support a means for transmitting a message including at least the first set of concatenated shaped symbols.

In some examples, the matrix representation component 845 may be configured as or otherwise support a means for mapping the first set of shaped symbols to a first time-frequency matrix representation of a resource grid, where segmenting the first set of shaped symbols is based on the first time-frequency matrix representation. In some examples, the matrix representation component 845 may be configured as or otherwise support a means for mapping the second set of shaped symbols to a second time-frequency matrix representation of the resource grid, where segmenting the second set of shaped symbols is based on the second time-frequency matrix representation.

In some examples, the first time-frequency matrix representation corresponds to a first quantity of frequency domain resources and a first quantity of time domain resources. In some examples, the second time-frequency matrix representation corresponds to a second quantity of frequency domain resources and a second quantity of time domain resources. In some examples, a quantity of subblocks of the first set of subblocks is associated with the first quantity of time domain resources. In some examples, a quantity of subblocks of the second set of subblocks is associated with the second quantity of time domain resources. In some examples, a quantity of symbols of the first set of concatenated shaped symbols is equal to a sum of the first quantity of frequency domain resources and the second quantity of frequency domain resources.

In some examples, the concatenation component 835 may be configured as or otherwise support a means for concatenating a third subblock of the first set of subblocks with a fourth subblock of the second set of subblocks to obtain a second set of concatenated shaped symbols, where the message further includes the second set of concatenated shaped symbols.

In some examples, the symbol-to-bit component 850 may be configured as or otherwise support a means for performing a first symbol-to-bit conversion operation on the first set of concatenated shaped symbols to obtain a first bit stream. In some examples, the symbol-to-bit component 850 may be configured as or otherwise support a means for performing a second symbol-to-bit conversion operation on the second set of concatenated shaped symbols to obtain a second bit stream.

In some examples, the interleaving component 865 may be configured as or otherwise support a means for interleaving the first bit stream and the second bit stream based on the first frequency subband and the second frequency subband to obtain an interleaved bit stream. In some examples, the encoding component 855 may be configured as or otherwise support a means for encoding the interleaved bit stream using an encoder of the wireless device, where transmitting the message is based on the encoding.

In some examples, the encoding component 855 may be configured as or otherwise support a means for generating a set of parity bits based on the first set of concatenated shaped symbols and the second set of concatenated shaped symbols, and the multiplexing component 870 may be configured as or otherwise support a means for multiplexing the set of parity bits with one or more unshaped information bits of the set of information bits, where transmitting the message is based on the multiplexing.

In some examples, the symbol-to-bit component 850 may be configured as or otherwise support a means for performing a symbol-to-bit conversion operation on the first set of concatenated shaped symbols to obtain a first bit stream. In some examples, the encoding component 855 may be configured as or otherwise support a means for encoding the first bit stream using an encoder of the wireless device, where transmitting the message is based on the encoding. In some examples, to support encoding the first bit stream, the encoding component 855 may be configured as or otherwise support a means for generating, using the encoder of the wireless device, a set of parity bits based on the first set of concatenated shaped symbols.

In some examples, the multiplexing component 870 may be configured as or otherwise support a means for multiplexing the set of parity bits with one or more unshaped information bits of the set of information bits to obtain a set of multiplexed bits. In some examples, the interleaving component 865 may be configured as or otherwise support a means for interleaving multiplexed bits of the set of multiplexed bits based on the first frequency subband and the second frequency subband, where transmitting the message is based on the interleaving.

In some examples, to support transmitting the message, the resource mapping component 860 may be configured as or otherwise support a means for mapping the first set of concatenated shaped symbols to a set of resources based on a frequency-first, time-second ordering, where the message is transmitted via the set of resources.

In some examples, a block size of the first distribution matcher is based on a size of the first frequency subband. In some examples, a block size of the second distribution matcher is based on a size of the second frequency subband. In some examples, the distribution matcher component 825 may be configured as or otherwise support a means for receiving control signaling indicating the size of the first frequency subband and the size of the second frequency subband. In some examples, the size of the first frequency subband and the size of the second frequency subband are based on a bandwidth.

In some examples, the distribution matcher component 825 may be configured as or otherwise support a means for receiving a signal indicating one or more parameters for the first distribution matcher, one or more parameters for the second distribution matcher, or a combination thereof.

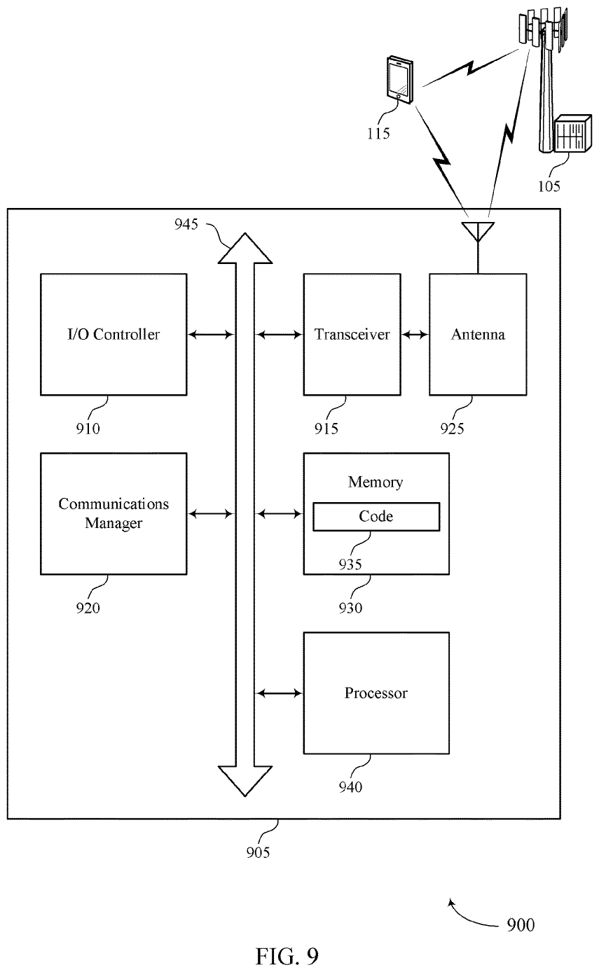

FIG. 9 illustrates a diagram of a system 900 including a device 905 that supports resource mapping for PAS in accordance with one or more aspects of the present disclosure. The device 905 may be an example of or include the components of a device 605, a device 705, or a UE 115 as described herein. The device 905 may communicate (e.g., wirelessly) with one or more network entities 105, one or more UEs 115, or any combination thereof. The device 905 may include components for bi-directional voice and data communications including components for transmitting and receiving communications, such as a communications manager 920, an input/output (I/O) controller 910, a transceiver 915, an antenna 925, a memory 930, code 935, and a processor 940. These components may be in electronic communication or otherwise coupled (e.g., operatively, communicatively, functionally, electronically, electrically) via one or more buses (e.g., a bus 945).

The I/O controller 910 may manage input and output signals for the device 905. The I/O controller 910 may also manage peripherals not integrated into the device 905. In some cases, the I/O controller 910 may represent a physical connection or port to an external peripheral. In some cases, the I/O controller 910 may utilize an operating system such as iOS®, ANDROID®, MS-DOS®, MS-WINDOWS®, OS/2®, UNIX®, LINUX®, or another known operating system. Additionally, or alternatively, the I/O controller 910 may represent or interact with a modem, a keyboard, a mouse, a touchscreen, or a similar device. In some cases, the I/O controller 910 may be implemented as part of a processor, such as the processor 940. In some cases, a user may interact with the device 905 via the I/O controller 910 or via hardware components controlled by the I/O controller 910.

In some cases, the device 905 may include a single antenna 925. However, in some other cases, the device 905 may have more than one antenna 925, which may be capable of concurrently transmitting or receiving multiple wireless transmissions. The transceiver 915 may communicate bi-directionally, via the one or more antennas 925, wired, or wireless links as described herein. For example, the transceiver 915 may represent a wireless transceiver and may communicate bi-directionally with another wireless transceiver. The transceiver 915 may also include a modem to modulate the packets, to provide the modulated packets to one or more antennas 925 for transmission, and to demodulate packets received from the one or more antennas 925. The transceiver 915, or the transceiver 915 and one or more antennas 925, may be an example of a transmitter 615, a transmitter 715, a receiver 610, a receiver 710, or any combination thereof or component thereof, as described herein.

The memory 930 may include random access memory (RAM) and read-only memory (ROM). The memory 930 may store computer-readable, computer-executable code 935 including instructions that, when executed by the processor 940, cause the device 905 to perform various functions described herein. The code 935 may be stored in a non-transitory computer-readable medium such as system memory or another type of memory. In some cases, the code 935 may not be directly executable by the processor 940 but may cause a computer (e.g., when compiled and executed) to perform functions described herein. In some cases, the memory 930 may contain, among other things, a basic I/O system (BIOS) which may control basic hardware or software operation such as the interaction with peripheral components or devices.

The processor 940 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 940 may be configured to operate a memory array using a memory controller. In some other cases, a memory controller may be integrated into the processor 940. The processor 940 may be configured to execute computer-readable instructions stored in a memory (e.g., the memory 930) to cause the device 905 to perform various functions (e.g., functions or tasks supporting resource mapping for PAS). For example, the device 905 or a component of the device 905 may include a processor 940 and memory 930 coupled with or to the processor 940, the processor 940 and memory 930 configured to perform various functions described herein.

The communications manager 920 may support wireless communications at a wireless device in accordance with examples as disclosed herein. For example, the communications manager 920 may be configured as or otherwise support a means for generating, using a first distribution matcher of the wireless device, a first set of shaped symbols corresponding to a first subset of a set of information bits, the first distribution matcher associated with a first frequency subband. The communications manager 920 may be configured as or otherwise support a means for generating, using a second distribution matcher of the wireless device, a second set of shaped symbols corresponding to a second subset of the set of information bits, the second distribution matcher associated with a second frequency subband. The communications manager 920 may be configured as or otherwise support a means for segmenting the first set of shaped symbols into a first set of subblocks, where each subblock of the first set of subblocks includes a respective subset of the first set of shaped symbols. The communications manager 920 may be configured as or otherwise support a means for segmenting the second set of shaped symbols into a second set of subblocks, where each subblock of the second set of subblocks includes a respective subset of the second set of shaped symbols. The communications manager 920 may be configured as or otherwise support a means for concatenating a first subblock of the first set of subblocks with a second subblock of the second set of subblocks to obtain a first set of concatenated shaped symbols, where the first set of concatenated shaped symbols is associated with the first frequency subband and the second frequency subband. The communications manager 920 may be configured as or otherwise support a means for transmitting a message including at least the first set of concatenated shaped symbols.

By including or configuring the communications manager 920 in accordance with examples as described herein, the device 905 may support techniques for a transmitting device, such as a network entity 105 or a UE 115, to perform distribution matching across time-domain and frequency-domain resources to obtain a bit sequence with a non-uniform probability distribution prior to constellation mapping, which may yield reduced processing, reduced power consumption, more efficient utilization of communication resources, improve coordination between devices, and the like.

In some examples, the communications manager 920 may be configured to perform various operations (e.g., receiving, monitoring, transmitting) using or otherwise in cooperation with the transceiver 915, the one or more antennas 925, or any combination thereof. Although the communications manager 920 is illustrated as a separate component, in some examples, one or more functions described with reference to the communications manager 920 may be supported by or performed by the processor 940, the memory 930, the code 935, or any combination thereof. For example, the code 935 may include instructions executable by the processor 940 to cause the device 905 to perform various aspects of resource mapping for PAS as described herein, or the processor 940 and the memory 930 may be otherwise configured to perform or support such operations.

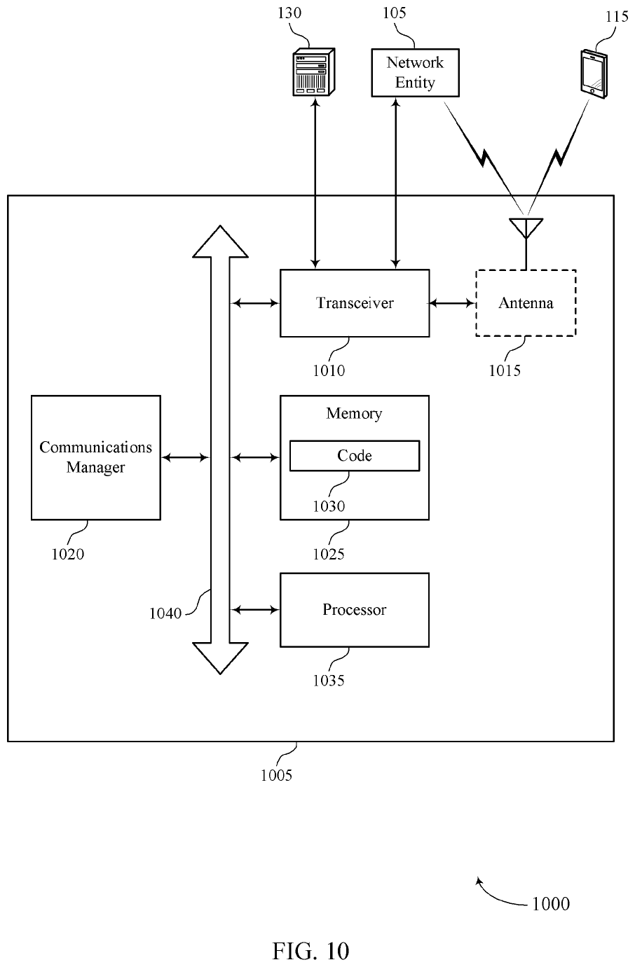

FIG. 10 illustrates a diagram of a system 1000 including a device 1005 that supports resource mapping for PAS in accordance with one or more aspects of the present disclosure. The device 1005 may be an example of or include the components of a device 605, a device 705, or a network entity 105 as described herein. The device 1005 may communicate with one or more network entities 105, one or more UEs 115, or any combination thereof, which may include communications over one or more wired interfaces, over one or more wireless interfaces, or any combination thereof. The device 1005 may include components that support outputting and obtaining communications, such as a communications manager 1020, a transceiver 1010, an antenna 1015, a memory 1025, code 1030, and a processor 1035. These components may be in electronic communication or otherwise coupled (e.g., operatively, communicatively, functionally, electronically, electrically) via one or more buses (e.g., a bus 1040).

The transceiver 1010 may support bi-directional communications via wired links, wireless links, or both as described herein. In some examples, the transceiver 1010 may include a wired transceiver and may communicate bi-directionally with another wired transceiver. Additionally, or alternatively, in some examples, the transceiver 1010 may include a wireless transceiver and may communicate bi-directionally with another wireless transceiver. In some examples, the device 1005 may include one or more antennas 1015, which may be capable of transmitting or receiving wireless transmissions (e.g., concurrently). The transceiver 1010 may also include a modem to modulate signals, to provide the modulated signals for transmission (e.g., by one or more antennas 1015, by a wired transmitter), to receive modulated signals (e.g., from one or more antennas 1015, from a wired receiver), and to demodulate signals. In some implementations, the transceiver 1010 may include one or more interfaces, such as one or more interfaces coupled with the one or more antennas 1015 that are configured to support various receiving or obtaining operations, or one or more interfaces coupled with the one or more antennas 1015 that are configured to support various transmitting or outputting operations, or a combination thereof. In some implementations, the transceiver 1010 may include or be configured for coupling with one or more processors or memory components that are operable to perform or support operations based on received or obtained information or signals, or to generate information or other signals for transmission or other outputting, or any combination thereof. In some implementations, the transceiver 1010, or the transceiver 1010 and the one or more antennas 1015, or the transceiver 1010 and the one or more antennas 1015 and one or more processors or memory components (for example, the processor 1035, or the memory 1025, or both), may be included in a chip or chip assembly that is installed in the device 1005. In some examples, the transceiver may be operable to support communications via one or more communications links (e.g., a communication link 125, a backhaul communication link 120, a midhaul communication link 162, a fronthaul communication link 168).

The memory 1025 may include RAM and ROM. The memory 1025 may store computer-readable, computer-executable code 1030 including instructions that, when executed by the processor 1035, cause the device 1005 to perform various functions described herein. The code 1030 may be stored in a non-transitory computer-readable medium such as system memory or another type of memory. In some cases, the code 1030 may not be directly executable by the processor 1035 but may cause a computer (e.g., when compiled and executed) to perform functions described herein. In some cases, the memory 1025 may contain, among other things, a BIOS which may control basic hardware or software operation such as the interaction with peripheral components or devices.

The processor 1035 may include an intelligent hardware device (e.g., a general-purpose processor, a DSP, an ASIC, a CPU, an FPGA, a microcontroller, a programmable logic device, discrete gate or transistor logic, a discrete hardware component, or any combination thereof). In some cases, the processor 1035 may be configured to operate a memory array using a memory controller. In some other cases, a memory controller may be integrated into the processor 1035. The processor 1035 may be configured to execute computer-readable instructions stored in a memory (e.g., the memory 1025) to cause the device 1005 to perform various functions (e.g., functions or tasks supporting resource mapping for PAS). For example, the device 1005 or a component of the device 1005 may include a processor 1035 and memory 1025 coupled with the processor 1035, the processor 1035 and memory 1025 configured to perform various functions described herein. The processor 1035 may be an example of a cloud-computing platform (e.g., one or more physical nodes and supporting software such as operating systems, virtual machines, or container instances) that may host the functions (e.g., by executing code 1030) to perform the functions of the device 1005. The processor 1035 may be any one or more suitable processors capable of executing scripts or instructions of one or more software programs stored in the device 1005 (such as within the memory 1025). In some implementations, the processor 1035 may be a component of a processing system. A processing system may generally refer to a system or series of machines or components that receives inputs and processes the inputs to produce a set of outputs (which may be passed to other systems or components of, for example, the device 1005). For example, a processing system of the device 1005 may refer to a system including the various other components or subcomponents of the device 1005, such as the processor 1035, or the transceiver 1010, or the communications manager 1020, or other components or combinations of components of the device 1005. The processing system of the device 1005 may interface with other components of the device 1005, and may process information received from other components (such as inputs or signals) or output information to other components. For example, a chip or modem of the device 1005 may include a processing system and one or more interfaces to output information, or to obtain information, or both. The one or more interfaces may be implemented as or otherwise include a first interface configured to output information and a second interface configured to obtain information, or a same interface configured to output information and to obtain information, among other implementations. In some implementations, the one or more interfaces may refer to an interface between the processing system of the chip or modem and a transmitter, such that the device 1005 may transmit information output from the chip or modem. Additionally, or alternatively, in some implementations, the one or more interfaces may refer to an interface between the processing system of the chip or modem and a receiver, such that the device 1005 may obtain information or signal inputs, and the information may be passed to the processing system. A person having ordinary skill in the art will readily recognize that a first interface also may obtain information or signal inputs, and a second interface also may output information or signal outputs.

In some examples, a bus 1040 may support communications of (e.g., within) a protocol layer of a protocol stack. In some examples, a bus 1040 may support communications associated with a logical channel of a protocol stack (e.g., between protocol layers of a protocol stack), which may include communications performed within a component of the device 1005, or between different components of the device 1005 that may be co-located or located in different locations (e.g., where the device 1005 may refer to a system in which one or more of the communications manager 1020, the transceiver 1010, the memory 1025, the code 1030, and the processor 1035 may be located in one of the different components or divided between different components).

In some examples, the communications manager 1020 may manage aspects of communications with a core network 130 (e.g., via one or more wired or wireless backhaul links). For example, the communications manager 1020 may manage the transfer of data communications for client devices, such as one or more UEs 115. In some examples, the communications manager 1020 may manage communications with other network entities 105, and may include a controller or scheduler for controlling communications with UEs 115 in cooperation with other network entities 105. In some examples, the communications manager 1020 may support an X2 interface within an LTE/LTE-A wireless communications network technology to provide communication between network entities 105.

The communications manager 1020 may support wireless communications at a wireless device in accordance with examples as disclosed herein. For example, the communications manager 1020 may be configured as or otherwise support a means for generating, using a first distribution matcher of the wireless device, a first set of shaped symbols corresponding to a first subset of a set of information bits, the first distribution matcher associated with a first frequency subband. The communications manager 1020 may be configured as or otherwise support a means for generating, using a second distribution matcher of the wireless device, a second set of shaped symbols corresponding to a second subset of the set of information bits, the second distribution matcher associated with a second frequency subband. The communications manager 1020 may be configured as or otherwise support a means for segmenting the first set of shaped symbols into a first set of subblocks, where each subblock of the first set of subblocks includes a respective subset of the first set of shaped symbols. The communications manager 1020 may be configured as or otherwise support a means for segmenting the second set of shaped symbols into a second set of subblocks, where each subblock of the second set of subblocks includes a respective subset of the second set of shaped symbols. The communications manager 1020 may be configured as or otherwise support a means for concatenating a first subblock of the first set of subblocks with a second subblock of the second set of subblocks to obtain a first set of concatenated shaped symbols, where the first set of concatenated shaped symbols is associated with the first frequency subband and the second frequency subband. The communications manager 1020 may be configured as or otherwise support a means for transmitting a message including at least the first set of concatenated shaped symbols.

By including or configuring the communications manager 1020 in accordance with examples as described herein, the device 1005 may support techniques for a transmitting device, such as a network entity 105 or a UE 115, to perform distribution matching across time-domain and frequency-domain resources to obtain a bit sequence with a non-uniform probability distribution prior to constellation mapping, which may yield reduced processing, reduced power consumption, more efficient utilization of communication resources, improve coordination between devices, and the like.

In some examples, the communications manager 1020 may be configured to perform various operations (e.g., receiving, obtaining, monitoring, outputting, transmitting) using or otherwise in cooperation with the transceiver 1010, the one or more antennas 1015 (e.g., where applicable), or any combination thereof. Although the communications manager 1020 is illustrated as a separate component, in some examples, one or more functions described with reference to the communications manager 1020 may be supported by or performed by the transceiver 1010, the processor 1035, the memory 1025, the code 1030, or any combination thereof. For example, the code 1030 may include instructions executable by the processor 1035 to cause the device 1005 to perform various aspects of resource mapping for PAS as described herein, or the processor 1035 and the memory 1025 may be otherwise configured to perform or support such operations.

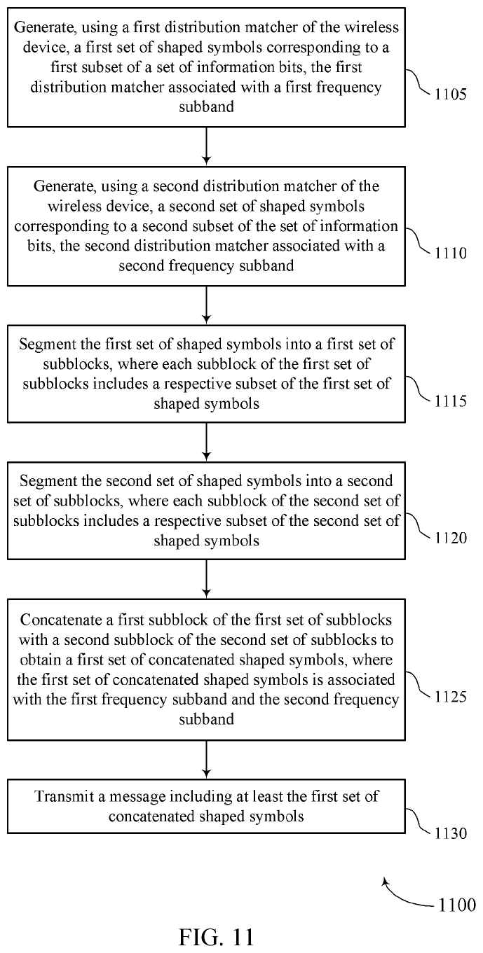

FIG. 11 illustrates a flowchart showing a method 1100 that supports resource mapping for PAS in accordance with one or more aspects of the present disclosure. The operations of the method 1100 may be implemented by a UE or a network entity or its components as described herein. For example, the operations of the method 1100 may be performed by a UE 115 or a network entity as described with reference to FIGS. 1 through 10. In some examples, a UE or a network entity may execute a set of instructions to control the functional elements of the UE or the network entity to perform the described functions. Additionally, or alternatively, the UE or the network entity may perform aspects of the described functions using special-purpose hardware.

At 1105, the method may include generating, using a first distribution matcher of the wireless device, a first set of shaped symbols corresponding to a first subset of a set of information bits, the first distribution matcher associated with a first frequency subband. The operations of 1105 may be performed in accordance with examples as disclosed herein. In some examples, aspects of the operations of 1105 may be performed by a distribution matcher component 825 as described with reference to FIG. 8.

At 1110, the method may include generating, using a second distribution matcher of the wireless device, a second set of shaped symbols corresponding to a second subset of the set of information bits, the second distribution matcher associated with a second frequency subband. The operations of 1110 may be performed in accordance with examples as disclosed herein. In some examples, aspects of the operations of 1110 may be performed by a distribution matcher component 825 as described with reference to FIG. 8.

At 1115, the method may include segmenting the first set of shaped symbols into a first set of subblocks, where each subblock of the first set of subblocks includes a respective subset of the first set of shaped symbols. The operations of 1115 may be performed in accordance with examples as disclosed herein. In some examples, aspects of the operations of 1115 may be performed by a subblock component 830 as described with reference to FIG. 8.

At 1120, the method may include segmenting the second set of shaped symbols into a second set of subblocks, where each subblock of the second set of subblocks includes a respective subset of the second set of shaped symbols. The operations of 1120 may be performed in accordance with examples as disclosed herein. In some examples, aspects of the operations of 1120 may be performed by a subblock component 830 as described with reference to FIG. 8.

At 1125, the method may include concatenating a first subblock of the first set of subblocks with a second subblock of the second set of subblocks to obtain a first set of concatenated shaped symbols, where the first set of concatenated shaped symbols is associated with the first frequency subband and the second frequency subband. The operations of 1125 may be performed in accordance with examples as disclosed herein. In some examples, aspects of the operations of 1125 may be performed by a concatenation component 835 as described with reference to FIG. 8.

At 1130, the method may include transmitting a message including at least the first set of concatenated shaped symbols. The operations of 1130 may be performed in accordance with examples as disclosed herein. In some examples, aspects of the operations of 1130 may be performed by a message transmitter 840 as described with reference to FIG. 8.

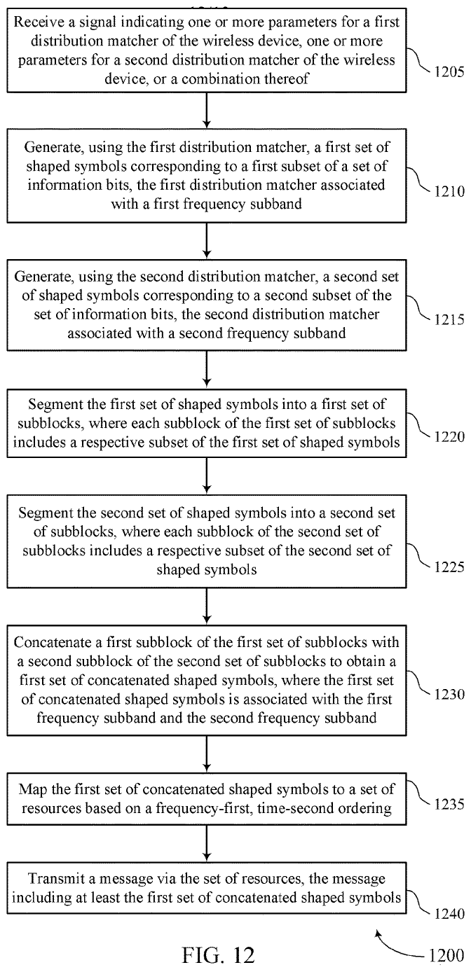

FIG. 12 illustrates a flowchart showing a method 1200 that supports resource mapping for PAS in accordance with one or more aspects of the present disclosure. The operations of the method 1200 may be implemented by a UE or a network entity or its components as described herein. For example, the operations of the method 1200 may be performed by a UE 115 or a network entity as described with reference to FIGS. 1 through 10. In some examples, a UE or a network entity may execute a set of instructions to control the functional elements of the UE or the network entity to perform the described functions. Additionally, or alternatively, the UE or the network entity may perform aspects of the described functions using special-purpose hardware.

At 1205, the method may include receiving a signal indicating one or more parameters for a first distribution matcher of the wireless device, one or more parameters for a second distribution matcher of the wireless device, or a combination thereof. The operations of 1205 may be performed in accordance with examples as disclosed herein. In some examples, aspects of the operations of 1205 may be performed by a distribution matcher component 825 as described with reference to FIG. 8.

At 1210, the method may include generating, using the first distribution matcher, a first set of shaped symbols corresponding to a first subset of a set of information bits, the first distribution matcher associated with a first frequency subband. The operations of 1210 may be performed in accordance with examples as disclosed herein. In some examples, aspects of the operations of 1210 may be performed by a distribution matcher component 825 as described with reference to FIG. 8.

At 1215, the method may include generating, using the second distribution matcher, a second set of shaped symbols corresponding to a second subset of the set of information bits, the second distribution matcher associated with a second frequency subband. The operations of 1215 may be performed in accordance with examples as disclosed herein. In some examples, aspects of the operations of 1215 may be performed by a distribution matcher component 825 as described with reference to FIG. 8.

At 1220, the method may include segmenting the first set of shaped symbols into a first set of subblocks, where each subblock of the first set of subblocks includes a respective subset of the first set of shaped symbols. The operations of 1220 may be performed in accordance with examples as disclosed herein. In some examples, aspects of the operations of 1220 may be performed by a subblock component 830 as described with reference to FIG. 8.

At 1225, the method may include segmenting the second set of shaped symbols into a second set of subblocks, where each subblock of the second set of subblocks includes a respective subset of the second set of shaped symbols. The operations of 1225 may be performed in accordance with examples as disclosed herein. In some examples, aspects of the operations of 1225 may be performed by a subblock component 830 as described with reference to FIG. 8.

At 1230, the method may include concatenating a first subblock of the first set of subblocks with a second subblock of the second set of subblocks to obtain a first set of concatenated shaped symbols, where the first set of concatenated shaped symbols is associated with the first frequency subband and the second frequency subband. The operations of 1230 may be performed in accordance with examples as disclosed herein. In some examples, aspects of the operations of 1230 may be performed by a concatenation component 835 as described with reference to FIG. 8.

At 1235, the method may include mapping the first set of concatenated shaped symbols to a set of resources based on a frequency-first, time-second ordering. The operations of 1235 may be performed in accordance with examples as disclosed herein. In some examples, aspects of the operations of 1235 may be performed by a resource mapping component 860 as described with reference to FIG. 8.

At 1240, the method may include transmitting a message including at least the first set of concatenated shaped symbols, where the message is transmitted via the set of resources. The operations of 1240 may be performed in accordance with examples as disclosed herein. In some examples, aspects of the operations of 1240 may be performed by a message transmitter 840 as described with reference to FIG. 8.

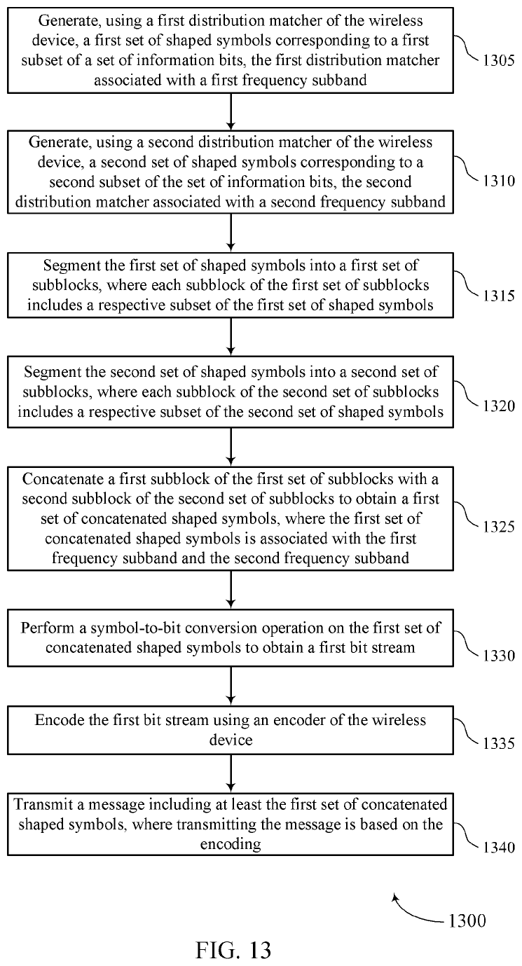

FIG. 13 illustrates a flowchart showing a method 1300 that supports resource mapping for PAS in accordance with one or more aspects of the present disclosure. The operations of the method 1300 may be implemented by a UE or a network entity or its components as described herein. For example, the operations of the method 1300 may be performed by a UE 115 or a network entity as described with reference to FIGS. 1 through 10. In some examples, a UE or a network entity may execute a set of instructions to control the functional elements of the UE or the network entity to perform the described functions. Additionally, or alternatively, the UE or the network entity may perform aspects of the described functions using special-purpose hardware.

At 1305, the method may include generating, using a first distribution matcher of the wireless device, a first set of shaped symbols corresponding to a first subset of a set of information bits, the first distribution matcher associated with a first frequency subband. The operations of 1305 may be performed in accordance with examples as disclosed herein. In some examples, aspects of the operations of 1305 may be performed by a distribution matcher component 825 as described with reference to FIG. 8.

At 1310, the method may include generating, using a second distribution matcher of the wireless device, a second set of shaped symbols corresponding to a second subset of the set of information bits, the second distribution matcher associated with a second frequency subband. The operations of 1310 may be performed in accordance with examples as disclosed herein. In some examples, aspects of the operations of 1310 may be performed by a distribution matcher component 825 as described with reference to FIG. 8.

At 1315, the method may include segmenting the first set of shaped symbols into a first set of subblocks, where each subblock of the first set of subblocks includes a respective subset of the first set of shaped symbols. The operations of 1315 may be performed in accordance with examples as disclosed herein. In some examples, aspects of the operations of 1315 may be performed by a subblock component 830 as described with reference to FIG. 8.

At 1320, the method may include segmenting the second set of shaped symbols into a second set of subblocks, where each subblock of the second set of subblocks includes a respective subset of the second set of shaped symbols. The operations of 1320 may be performed in accordance with examples as disclosed herein. In some examples, aspects of the operations of 1320 may be performed by a subblock component 830 as described with reference to FIG. 8.

At 1325, the method may include concatenating a first subblock of the first set of subblocks with a second subblock of the second set of subblocks to obtain a first set of concatenated shaped symbols, where the first set of concatenated shaped symbols is associated with the first frequency subband and the second frequency subband. The operations of 1325 may be performed in accordance with examples as disclosed herein. In some examples, aspects of the operations of 1325 may be performed by a concatenation component 835 as described with reference to FIG. 8.

At 1330, the method may include performing a symbol-to-bit conversion operation on the first set of concatenated shaped symbols to obtain a first bit stream. The operations of 1330 may be performed in accordance with examples as disclosed herein. In some examples, aspects of the operations of 1330 may be performed by a symbol-to-bit component 850 as described with reference to FIG. 8.

At 1335, the method may include encoding the first bit stream using an encoder of the wireless device. The operations of 1335 may be performed in accordance with examples as disclosed herein. In some examples, aspects of the operations of 1335 may be performed by an encoding component 855 as described with reference to FIG. 8.

At 1340, the method may include transmitting a message including at least the first set of concatenated shaped symbols, where transmitting the message is based on the encoding. The operations of 1340 may be performed in accordance with examples as disclosed herein. In some examples, aspects of the operations of 1340 may be performed by a message transmitter 840 as described with reference to FIG. 8.

The following provides an overview of aspects of the present disclosure:
Aspect 1: A method for wireless communications at a wireless device, comprising: generating, using a first distribution matcher of the wireless device, a first set of shaped symbols corresponding to a first subset of a set of information bits, the first distribution matcher associated with a first frequency subband; generating, using a second distribution matcher of the wireless device, a second set of shaped symbols corresponding to a second subset of the set of information bits, the second distribution matcher associated with a second frequency subband; segmenting the first set of shaped symbols into a first set of subblocks, wherein each subblock of the first set of subblocks comprises a respective subset of the first set of shaped symbols; segmenting the second set of shaped symbols into a second set of subblocks, wherein each subblock of the second set of subblocks comprises a respective subset of the second set of shaped symbols; concatenating a first subblock of the first set of subblocks with a second subblock of the second set of subblocks to obtain a first set of concatenated shaped symbols, wherein the first set of concatenated shaped symbols is associated with the first frequency subband and the second frequency subband; and transmitting a message including at least the first set of concatenated shaped symbols.
Aspect 2: The method of aspect 1, further comprising: mapping the first set of shaped symbols to a first time-frequency matrix representation of a resource grid, wherein segmenting the first set of shaped symbols is based at least in part on the first time-frequency matrix representation; and mapping the second set of shaped symbols to a second time-frequency matrix representation of the resource grid, wherein segmenting the second set of shaped symbols is based at least in part on the second time-frequency matrix representation.
Aspect 3: The method of aspect 2, wherein the first time-frequency matrix representation corresponds to a first quantity of frequency domain resources and a first quantity of time domain resources, and the second time-frequency matrix representation corresponds to a second quantity of frequency domain resources and a second quantity of time domain resources.
Aspect 4: The method of aspect 3, wherein a quantity of subblocks of the first set of subblocks is associated with the first quantity of time domain resources, and a quantity of subblocks of the second set of subblocks is associated with the second quantity of time domain resources.
Aspect 5: The method of any of aspects 3 through 4, wherein a quantity of symbols of the first set of concatenated shaped symbols is equal to a sum of the first quantity of frequency domain resources and the second quantity of frequency domain resources.
Aspect 6: The method of any of aspects 1 through 5, further comprising: concatenating a third subblock of the first set of subblocks with a fourth subblock of the second set of subblocks to obtain a second set of concatenated shaped symbols, wherein the message further includes the second set of concatenated shaped symbols.
Aspect 7: The method of aspect 6, further comprising: performing a first symbol-to-bit conversion operation on the first set of concatenated shaped symbols to obtain a first bit stream; and performing a second symbol-to-bit conversion operation on the second set of concatenated shaped symbols to obtain a second bit stream.
Aspect 8: The method of aspect 7, further comprising: interleaving the first bit stream and the second bit stream based at least in part on the first frequency subband and the second frequency subband to obtain an interleaved bit stream; and encoding the interleaved bit stream using an encoder of the wireless device, wherein transmitting the message is based at least in part on the encoding.
Aspect 9: The method of aspect 8, wherein encoding the interleaved bit stream comprises generating a set of parity bits based at least in part on the first set of concatenated shaped symbols and the second set of concatenated shaped symbols, the method further comprising: multiplexing the set of parity bits with one or more unshaped information bits of the set of information bits, wherein transmitting the message is based at least in part on the multiplexing.
Aspect 10: The method of any of aspects 1 through 5, further comprising: performing a symbol-to-bit conversion operation on the first set of concatenated shaped symbols to obtain a first bit stream; and encoding the first bit stream using an encoder of the wireless device, wherein transmitting the message is based at least in part on the encoding.
Aspect 11: The method of aspect 10, wherein encoding the first bit stream comprises: generating, using the encoder of the wireless device, a set of parity bits based at least in part on the first set of concatenated shaped symbols.
Aspect 12: The method of aspect 11, further comprising: multiplexing the set of parity bits with one or more unshaped information bits of the set of information bits to obtain a set of multiplexed bits; and interleaving multiplexed bits of the set of multiplexed bits based at least in part on the first frequency subband and the second frequency subband, wherein transmitting the message is based at least in part on the interleaving.
Aspect 13: The method of any of aspects 1 through 12, wherein transmitting the message further comprises: mapping the first set of concatenated shaped symbols to a set of resources based at least in part on a frequency-first, time-second ordering, wherein the message is transmitted via the set of resources.
Aspect 14: The method of any of aspects 1 through 13, wherein a block size of the first distribution matcher is based at least in part on a size of the first frequency subband, and a block size of the second distribution matcher is based at least in part on a size of the second frequency subband.
Aspect 15: The method of aspect 14, further comprising: receiving control signaling indicating the size of the first frequency subband and the size of the second frequency subband.
Aspect 16: The method of any of aspects 14 through 15, wherein the size of the first frequency subband and the size of the second frequency subband are based at least in part on a bandwidth.
Aspect 17: The method of any of aspects 1 through 16, further comprising: receiving a signal indicating one or more parameters for the first distribution matcher, one or more parameters for the second distribution matcher, or a combination thereof.
Aspect 18: An apparatus for wireless communications at a wireless device, comprising a processor; memory coupled with the processor; and instructions stored in the memory and executable by the processor to cause the apparatus to perform a method of any of aspects 1 through 17.
Aspect 19: An apparatus for wireless communications at a wireless device, comprising at least one means for performing a method of any of aspects 1 through 17.
Aspect 20: A non-transitory computer-readable medium storing code for wireless communications at a wireless device, the code comprising instructions executable by a processor to perform a method of any of aspects 1 through 17.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc. Disks may reproduce data magnetically, and discs may reproduce data optically using lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

The term “determine” or “determining” encompasses a variety of actions and, therefore, “determining” can include calculating, computing, processing, deriving, investigating, looking up (such as via looking up in a table, a database or another data structure), ascertaining and the like. Also, “determining” can include receiving (e.g., receiving information), accessing (e.g., accessing data stored in memory) and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

1. An apparatus for wireless communications at a wireless device, comprising:
a processor;
memory coupled with the processor; and
instructions stored in the memory and executable by the processor to cause the apparatus to:
generate, using a first distribution matcher of the wireless device, a first set of shaped symbols corresponding to a first subset of a set of information bits, the first distribution matcher associated with a first frequency subband;
generate, using a second distribution matcher of the wireless device, a second set of shaped symbols corresponding to a second subset of the set of information bits, the second distribution matcher associated with a second frequency subband;
segment the first set of shaped symbols into a first set of subblocks, wherein each subblock of the first set of subblocks comprises a respective subset of the first set of shaped symbols;
segment the second set of shaped symbols into a second set of subblocks, wherein each subblock of the second set of subblocks comprises a respective subset of the second set of shaped symbols;
concatenate a first subblock of the first set of subblocks with a second subblock of the second set of subblocks to obtain a first set of concatenated shaped symbols, wherein the first set of concatenated shaped symbols is associated with the first frequency subband and the second frequency subband; and
transmit a message including at least the first set of concatenated shaped symbols.

2. The apparatus of claim 1, wherein the instructions are further executable by the processor to cause the apparatus to:
map the first set of shaped symbols to a first time-frequency matrix representation of a resource grid, wherein segmenting the first set of shaped symbols is based at least in part on the first time-frequency matrix representation; and
map the second set of shaped symbols to a second time-frequency matrix representation of the resource grid, wherein segmenting the second set of shaped symbols is based at least in part on the second time-frequency matrix representation.

3. The apparatus of claim 2, wherein:
the first time-frequency matrix representation corresponds to a first quantity of frequency domain resources and a first quantity of time domain resources; and
the second time-frequency matrix representation corresponds to a second quantity of frequency domain resources and a second quantity of time domain resources.

4. The apparatus of claim 3, wherein:
a quantity of subblocks of the first set of subblocks is associated with the first quantity of time domain resources; and
a quantity of subblocks of the second set of subblocks is associated with the second quantity of time domain resources.

5. The apparatus of claim 3, wherein a quantity of symbols of the first set of concatenated shaped symbols is equal to a sum of the first quantity of frequency domain resources and the second quantity of frequency domain resources.

6. The apparatus of claim 1, wherein the instructions are further executable by the processor to cause the apparatus to:
concatenate a third subblock of the first set of subblocks with a fourth subblock of the second set of subblocks to obtain a second set of concatenated shaped symbols, wherein the message further includes the second set of concatenated shaped symbols.

7. The apparatus of claim 6, wherein the instructions are further executable by the processor to cause the apparatus to:
perform a first symbol-to-bit conversion operation on the first set of concatenated shaped symbols to obtain a first bit stream; and
perform a second symbol-to-bit conversion operation on the second set of concatenated shaped symbols to obtain a second bit stream.

8. The apparatus of claim 7, wherein the instructions are further executable by the processor to cause the apparatus to:
interleave the first bit stream and the second bit stream based at least in part on the first frequency subband and the second frequency subband to obtain an interleaved bit stream; and
encode the interleaved bit stream using an encoder of the wireless device, wherein encoding the interleaved bit stream comprises generating a set of parity bits based at least in part on the first set of concatenated shaped symbols and the second set of concatenated shaped symbols, and wherein transmitting the message is based at least in part on the encoding.

9. The apparatus of claim 8, wherein the instructions are further executable by the processor to cause the apparatus to:
multiplex the set of parity bits with one or more unshaped information bits of the set of information bits, wherein transmitting the message is based at least in part on the multiplexing.

10. The apparatus of claim 1, wherein the instructions are further executable by the processor to cause the apparatus to:
perform a symbol-to-bit conversion operation on the first set of concatenated shaped symbols to obtain a first bit stream; and
encode the first bit stream using an encoder of the wireless device, wherein transmitting the message is based at least in part on the encoding.

11. The apparatus of claim 10, wherein the instructions to encode the first bit stream are executable by the processor to cause the apparatus to:
generate, using the encoder of the wireless device, a set of parity bits based at least in part on the first set of concatenated shaped symbols.

12. The apparatus of claim 11, wherein the instructions are further executable by the processor to cause the apparatus to:
multiplex the set of parity bits with one or more unshaped information bits of the set of information bits to obtain a set of multiplexed bits; and
interleaving multiplexed bits of the set of multiplexed bits based at least in part on the first frequency subband and the second frequency subband, wherein transmitting the message is based at least in part on the interleaving.

13. The apparatus of claim 1, wherein the instructions to transmit the message are further executable by the processor to cause the apparatus to:
map the first set of concatenated shaped symbols to a set of resources based at least in part on a frequency-first, time-second ordering, wherein the message is transmitted via the set of resources.

14. The apparatus of claim 1, wherein:
a block size of the first distribution matcher is based at least in part on a size of the first frequency subband; and
a block size of the second distribution matcher is based at least in part on a size of the second frequency subband.

15. The apparatus of claim 14, wherein the instructions are further executable by the processor to cause the apparatus to:
receive control signaling indicating the size of the first frequency subband and the size of the second frequency subband.

16. The apparatus of claim 14, wherein the size of the first frequency subband and the size of the second frequency subband are based at least in part on a bandwidth.

17. The apparatus of claim 1, wherein the instructions are further executable by the processor to cause the apparatus to:
receive a signal indicating one or more parameters for the first distribution matcher, one or more parameters for the second distribution matcher, or a combination thereof.

18. A method for wireless communications at a wireless device, comprising:
generating, using a first distribution matcher of the wireless device, a first set of shaped symbols corresponding to a first subset of a set of information bits, the first distribution matcher associated with a first frequency subband;
generating, using a second distribution matcher of the wireless device, a second set of shaped symbols corresponding to a second subset of the set of information bits, the second distribution matcher associated with a second frequency subband;
segmenting the first set of shaped symbols into a first set of subblocks, wherein each subblock of the first set of subblocks comprises a respective subset of the first set of shaped symbols;
segmenting the second set of shaped symbols into a second set of subblocks, wherein each subblock of the second set of subblocks comprises a respective subset of the second set of shaped symbols;
concatenating a first subblock of the first set of subblocks with a second subblock of the second set of subblocks to obtain a first set of concatenated shaped symbols, wherein the first set of concatenated shaped symbols is associated with the first frequency subband and the second frequency subband; and
transmitting a message including at least the first set of concatenated shaped symbols.

19-26. (canceled)

27. The method of claim 18, further comprising:
performing a symbol-to-bit conversion operation on the first set of concatenated shaped symbols to obtain a first bit stream; and
encoding the first bit stream using an encoder of the wireless device, wherein transmitting the message is based at least in part on the encoding.

28-29. (canceled)

30. A non-transitory computer-readable medium storing code for wireless communications at a wireless device, the code comprising instructions executable by a processor to:
generate, using a first distribution matcher of the wireless device, a first set of shaped symbols corresponding to a first subset of a set of information bits, the first distribution matcher associated with a first frequency subband;
generate, using a second distribution matcher of the wireless device, a second set of shaped symbols corresponding to a second subset of the set of information bits, the second distribution matcher associated with a second frequency subband;
segment the first set of shaped symbols into a first set of subblocks, wherein each subblock of the first set of subblocks comprises a respective subset of the first set of shaped symbols;
segment the second set of shaped symbols into a second set of subblocks, wherein each subblock of the second set of subblocks comprises a respective subset of the second set of shaped symbols;
concatenate a first subblock of the first set of subblocks with a second subblock of the second set of subblocks to obtain a first set of concatenated shaped symbols, wherein the first set of concatenated shaped symbols is associated with the first frequency subband and the second frequency subband; and
transmit a message including at least the first set of concatenated shaped symbols.
